(19) United States
(12) Patent Application Publication
(10) Pub. No.: US 2002/0174201 A1
(43) Pub. Date: Nov. 21, 2002

(54) Dynamic configuration of context-sensitive personal sites and membership channels

(76) Inventors: Jon E. Ramer, Bellevue, WA (US); Cisco Frank Lacson, Redmond, WA (US); Tom W. Corddry, Seattle, WA (US)

Correspondence Address: DORSEY & WHITNEY LLP, Suite 4700, 370 17th Street, Denver, CO, 80202-5647, US

(21) Appl. No.: 10/086,592

(22) Filed: Feb. 27, 2002

Related U.S. Application Data
(63) Continuation-in-part of application No. 09/672,029, filed on Sep. 29, 2000.
(60) Provisional application No. 60/156,956, filed on Sep. 30, 1999.

(51) Int. Cl. G06F 15/177

(52) U.S. Cl. 709/220; 709/226

(57) ABSTRACT

A personal site for organizing network content. The site includes one or more channels, and each channel is associated with sub-nodes. The channel is dynamically linked with the sub-nodes, and each sub-node can have one or more associated pages. The sub-nodes and the pages can include pointers to content such as uniform resource locators. Upon a user logging in, the site dynamically retrieves and builds a representation of the organized content and displays a node structure for the representation. The user can dynamically configure the representation by dragging and dropping items, such as content or network addresses, into the displayed node structure. The user can also specify master nodes for use in publishing content to user groups. The master nodes are copied, such as through dragging and dropping, into user groups, and each instance of the master node in the user groups inherits the user-specified properties of the master node. The user can also specify custom nodes having user-specified properties and fields, and can specify query nodes having search queries used to dynamically retrieve and expand sub-nodes for the query node.

### REFERENCE TO RELATED APPLICATIONS

The present application is a continuation-in-part of U.S. patent application Ser. No. 09/672,029, entitled “Context-Sensitive Personal Sites and Membership Channels,” filed Sep. 29, 2000, which claims priority to U.S. provisional patent application Serial No. 60/156,956, entitled “SmartChannels.Net™: Context-Sensitive Personal Sites and Membership Channels,” and filed Sep. 30, 1999, both of which are incorporated herein by reference as if fully set forth.

### FIELD OF THE INVENTION

The present invention relates to an apparatus and method for implementing a dynamic reconfigurable personal site for organizing, retrieving, and displaying content from a network such as the Internet.

### BACKGROUND OF THE INVENTION

Browser programs permit the retrieval and display of content from the Internet. Browsers access web sites using Uniform Resource Locators (URLs) and display the content in pages. In order to locate content, a user must know the URL identifying the location of the content and enter it into the browser. Alternatively, a user can access an on-line search engine to search for content on the Internet using key words. Search engines, however, often retrieve much irrelevant content since information on the Internet is not organized in a consistent or structured manner. Therefore, locating particular content on the Internet can be a time-consuming and frustrating process. In addition, when content is located at a particular web site, a user typically must manually access the web site each time content from the site is desired. This process requires the user to remember or specify the URLs for the various web sites and manually access them with the browser. The browser, however, does not permit the user to organize the content or collection of URLs in any manner.

Accordingly, a need exists for improvements in accessing, displaying, and organizing content from the Internet or other type of network.

### SUMMARY OF THE INVENTION

A first apparatus and method consistent with the present invention provide dynamic modification of an hierarchical structure for electronically organizing content in a channel communicating over a network with content sites. The structure specifies a channel node having a network address and hierarchically arranged sub-nodes each selectively having a pointer to particular content and links specifying the hierarchy. The apparatus and method display a representation of the structure. A selection of a node and an identification of a location to insert the node within the hierarchical structure are received during a user session. The node is temporarily inserted within the hierarchical structure during the user session and then established as part of the hierarchical structure for retrieval and use during a subsequent user session.

A second apparatus and method consistent with the present invention provide for master nodes in the hierarchical structure. The apparatus and method display a representation of the hierarchical structure, including display of at least one master node. A selection of the master node and an identification of a location to insert the master node within the hierarchical structure are received during a user session, and a representation of the master node is inserted in the identified location of the hierarchical structure. Upon receiving changes to the master node, those changes are automatically propagated to the inserted master nodes in the hierarchical structure.

A third apparatus and method consistent with the present invention provide for custom nodes in the hierarchical structure. The apparatus and method display a representation of the structure. A selection of a node and user-specified properties for the node are received during a user session, and the node is classified as a custom node controlled by the user-specified properties. The custom node is inserted in the hierarchical structure upon receiving an identification of a location to insert it. The custom nodes can include default or preconfigured nodes, or include nodes configured by a user.

A query node, one example of a custom node, specifies a search query for its sub-nodes. Upon selection of the query node, the search query is used to dynamically obtain information for the sub-nodes and expand the query node using that information.

### BRIEF DESCRIPTION OF THE DRAWINGS

The accompanying drawings are incorporated in and constitute a part of this specification and, together with the drawings, explain the advantages and principles of the invention. In the drawings,

FIG. 1 is a diagram illustrating a navigator accessing various channels and displaying content using a browser;

FIG. 2 is a diagram illustrating a node structure for a channel;

FIG. 3 is a diagram of exemplary components of a machine for using the navigator;

FIG. 4 is a flow chart of an administration routine;

FIGS. 5a and 5b are a flow chart of a navigator routine;

FIG. 6 is a screen illustrating display of channel nodes for selection;

FIG. 7 is a screen illustrating node identifiers associated with the nodes for selection;

FIGS. 8-26 are diagrams of an exemplary database schema for implementing the navigator and a channel;

FIG. 27 is a diagram illustrating a “drag and drop” feature to dynamically configure a node structure for a user's site;

FIG. 28 is a diagram illustrating configuration of master nodes;

FIG. 29 is a diagram illustrating use of master nodes.

FIGS. 30 and 31 are a flow chart of a method for dynamic configuration of a node structure for a user's site;

FIG. 32 is a screen for specifying channel properties

FIG. 33 is a screen for specifying user properties;

FIG. 34 is a screen for specifying user group properties;

FIG. 35 is a screen for specifying node properties; and

FIG. 36 is a screen for specifying custom node properties.

### DETAILED DESCRIPTION

### Introduction

SmartChannels.Net™ (“SmartChannels”) is a platform and tools for building a new generation of computing and communication applications that bring together the worlds of personal computers, legacy systems, and the Internet. The terms “SmartChannels.net” and “SmartChannels” are trademarks of SmartChannels.net and are used only as labels for one exemplary embodiment.

SmartChannels is page numbering for the Internet. SmartChannels provides context-sensitive membership channels that are dynamically configured web-enabled applications embracing and integrating the Internet and client/server models of computing. These SmartChannels are facilities through which cooperating people and systems can organize and coordinate the exchange of data and documents, and maintain a shared context for collaboration and communication. This collaboration and communication is accomplished by members (or subscribers) accessing a personal site that is connected to SmartChannels Identity and Context management software.

Each SmartChannel is a self-contained system that unlocks internally and externally stored content and functionality and provides subscribers with a single source for personalized information and action. The content can be located at a variety of locations, including, for example, on a local hard-drive, a company's internal file server, Intranet, databases, third-party databases, Extranet, or Internet web sites. SmartChannels are designed to deliver context-sensitive content to a subscriber's own secure personal site. For example, a user can enter a channel sometimes as an employee and sometimes as a parent. The personal site provides access to content relevant to a specific role or inquiry initiated by the subscriber. Therefore, SmartChannels is an intelligent means of passage for content and work to flow within the setting of a unifying purpose or identity.

SmartChannels is a new kind of web channel technology that makes the Internet easier to use and more meaningful. SmartChannels offers a flexible, personalized, and adaptive platform for enabling “trust relationships” with members and resources. The underlying SmartChannels technology is subject matter independent, and therefore, has broad commercial applicability.

The SmartChannels membership channels are structured into a number of sub-systems. These sub-systems include: architecture, programming, networking, and platform integration. A number of architectural models are discussed below, and in the architectural overview in the related provisional application, to illustrate the sub-system structure of the channels. The models describe the SmartChannels technology from seven vantage-points: conceptual, logical, software application components, product platform, market applications, physical architecture, and security architecture.

According to the logical architecture, SmartChannels is a pipe with two ends. Assuring access to the systems that provide services, data, and applications to the subscribers is addressed on the right-hand side of the pipe. Making all the content and actions relevant and easier to use to the subscribers is addressed by the left-hand side of the channel. SmartChannel manages the context of the content and the identity of the subscriber to provide the content to the subscriber in a relevant and meaningful manner.

A SmartChannel can be sponsored by an entity such as a business, an institution, or an organization. The entity sponsors the SmartChannel for its members, whether they are employees, customers, or other affiliated members. Individual members have their own personal site. This site may or may not include visitors. The individual members each have a data double or a “virtual me” which is a name space on a server that is representative of the member. The name space will have a user repository of data and information that identifies the member. Each individual member may have multiple data doubles representing the individual in a different manner (e.g., a business data double and a personnel life data double).

The personal sites serve the individual members. The personal sites are unique, personalized, customizable, and adaptable. These sites provide the individual members with context-sensitive navigation and transactions. By managing the context and the subscriber's identity (the data double), the personal site provides information that is relevant and of interest to the subscriber from the network. When the subscriber accesses through the personal site, the identity or data double virtually moves with the subscriber so that the service providers provide targeted and relevant services and information based on the data double. Using privacy preferences, the SmartChannel exchanges information from the subscriber's data double with the service providers to provide more personalized content. The subscriber's personal information can be distributed without making the information personally identifiable to the subscriber. SmartChannel only shares the subscriber's information to the extent the subscriber has an authorized SmartChannel. In this manner, the SmartChannel provides enhanced browsing for the subscriber.

One manner in which the SmartChannel provides enhanced browsing is through the selection navigator. The selection navigator is part of the adaptive framework. The selection navigator provides a hierarchal listing of a site's different areas with sections and pages. This hierarchal listing is a static approach, but, the selection navigator also provides a dynamic approach. The subscriber can provide explicit search criteria, and utilizing Structured Query Language (SQL), the selection navigator will dynamically assemble the web pages corresponding to that criteria; for example, for the query “show me the products that match my profile”, web pages corresponding to that criteria will be found and assembled for easy browsing by the selection navigator. Grouped SQL criteria can be used so that the selection navigator stores the criteria and updates the dynamically assembled web pages corresponding to the criteria when new data appears. The selection navigator is flexible and works in the back-end, or behind the scenes using back-end rules and logic.

The back-end services and rules permit matching to be done. One type of possible matching is life-event matching. For example, if a member provides information about life events such as a promotion, a marriage, or a pregnancy, SmartChannels can be triggered to provide content suited to those events. For example, the SmartChannel might have a relationship with a baby-food manufacturer, and might inform the baby-food manufacturer that some of its members are having babies. In exchange for this information, the baby-food manufacturer might provide discounts on baby food. The personal site of the pregnant members would then say: “congratulations on your up-coming baby . . . here is some discount on baby-food.”

Therefore, SmartChannels acts as a intermediary between service providers, the SmartChannel sponsor, and the members. The service provider may be a benefits provider, such as healthcare or a 401 (k) manager. SmartChannels provides assurance to the member of security and privacy to the extent desired and permission-based access to the members for the service provider. SmartChannels organizes and coordinates the content provided by the service providers based on the information in the data double provided by the members. The organized and coordinated content is presented through the members personal site. The member specifies what level of information from the data double to be released to the service providers. The greater level or more information released, the better context and identity management provided.

Through the SmartChannels, the service providers can specifically make privacy proposals to the members. For example, the baby-food manufacturer can propose free one-month supply of diapers in exchange for the members actual identity and address. The member can determine what information will be provided, what may be shared and with what service providers it may be shared, how the information will be used, and whether the data is to be used in an identifiable way. The member can delegate to SmartChannels decisions about exactly how the member wants information shared and can tailor the member preferences so that there is a web of trust around the web site. The SmartChannel enables this customization of the member's personal site.

A SmartChannel can also facilitate exchange of information between service providers or others. In particular, service providers can specify on their personal site how to interact with them and order services from them. Therefore, anyone requesting services from them can access the service provider's channel and obtain the necessary specifications for ordering from the service provider. Those specifications can be set forth, for example, in Extensible Markup Language (XML). An example of specifications for business-to-business exchange of information is the Universal Description, Discovery and Integration (UDDI) specifications, described in the following documents, which are incorporated herein by reference: UDDI XML Structure Reference, UDDI Programmer's API Specification, UDDI Executive White Paper, and UDDI Technical White Paper, all by Ariba, Inc., International Business Machines Corporation and Microsoft Corporation, Sep. 6, 2000.

The channels can exist for a wide variety of domains. Examples include, but are not limited to, the following categories: world; spirituality; education; play; money; health; family; and work and career. A channel for each of these categories can be organized with a node structure that, for example, further divides the category into sub-categories among the sub-nodes. The content for the channels can be dynamically changed, as well as the node structure for it. The domains can be sponsored or accessed by, for example, individuals, groups, corporations, business entities, retail establishments, or any other entity. Any combination of sponsors and channels (domains) can exist.

### Channel Structure for Personal Site

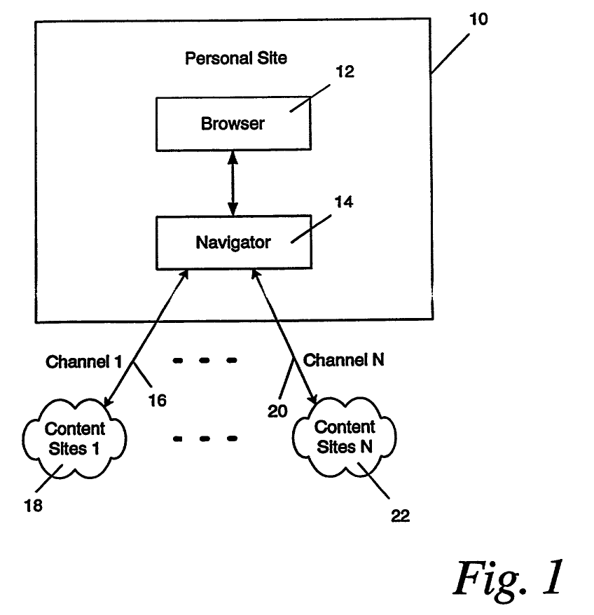

FIG. 1 is a diagram illustrating a navigator accessing various channels and displaying content using a browser for a personal site 10 to implement a SmartChannel. A navigator 14, implemented as a software program, operates essentially as a wrapper around a browser 12. Navigator 14 uses browser 12 to implement various channels 16 to 20. Each channel contains a collection of nodes and pages, explained below, for organizing content, and each node can be associated with a particular URL for use in retrieving content. The term “node” refers to any structured elements that can be linked together, and the term “page” refers to any collection of content for display. Using browser 12, navigator 14 accesses various content sites 18 to 22 via channels 16 to 20 for retrieving and displaying content to the user. The content sites can exist, for example, at those locations identified above, either remote from the user's machine or local to it.

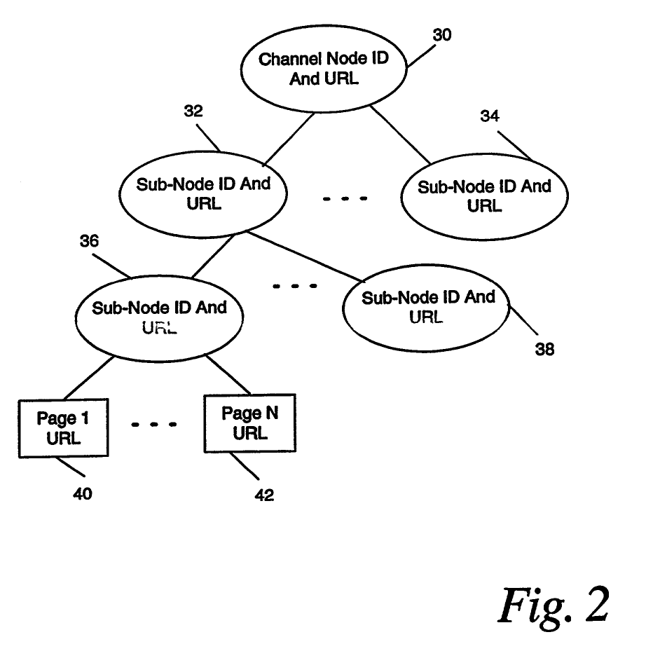

FIG. 2 is a diagram illustrating a node structure for a channel such as channel 16 or 20. Each channel includes a collection of nodes having parent-child relationships for organizing the content of the channel. Each channel includes a channel node ID and URL 30, or other network address, defining an entry point to the channel. Each channel node 30 can be linked with sub-nodes 32 to 34, and each sub-node can be further linked to nodes at another level such as nodes 36 to 38 for sub-node 32. Each sub-node at a lowest level can be selectively linked, meaning it can be linked but does not necessarily need to be, with particular pages, such as pages 40 to 42 for sub-node 36. The content for the pages can be obtained using the URL for the corresponding sub-node. Pages 40 to 42 can be formatted, for example, as web pages in HyperText Markup Language (HTML) or in another format.

As shown, each node and page can be selectively linked, meaning it can be linked but does not necessarily need to be, with a particular URL or pointer for use in retrieving content. The nodes can be further associated with node identifiers for use in organizing and linking them. Each node can thus be used to retrieve and display content, in addition to organizing the content. For example, channel node 30 can be associated with a home page identifying the channel, and each sub-node can be associated with an introductory page identifying or explaining content in lower levels linked to the sub-nodes.

The channel can include multiple hierarchical levels having more or fewer levels than shown and having any number of nodes at a particular level. This type of structure permits flexibility in defining a dynamic organization of networked content, and each channel can be dynamically reconfigured by adding or deleting nodes. The channel thus includes both content and context. The content is the actual data or information, and the context is the manner in which it is organized with the node structure. Appendix A includes an example of nodes for a channel and the linking of nodes and pages using node identifiers and page identifiers.

Appendix A also illustrates the ability to perform searching, sorting, and other similar functions on the list of nodes. The first page of Appendix A illustrates sections to enter a column value, a comparison such as a Boolean operation, and a value. Selection of the filter button can trigger a program to electronically search or sort through the nodes satisfying the information entered in the column, comparison, and value sections. Therefore, a user can search or sort the list for nodes relating to a particular topic or type of content. Other types of searching and sorting can be performed on the list of nodes, using conventional programs for electronically searching and sorting information, to manage the list of nodes.

### Machine for Executing the Navigator

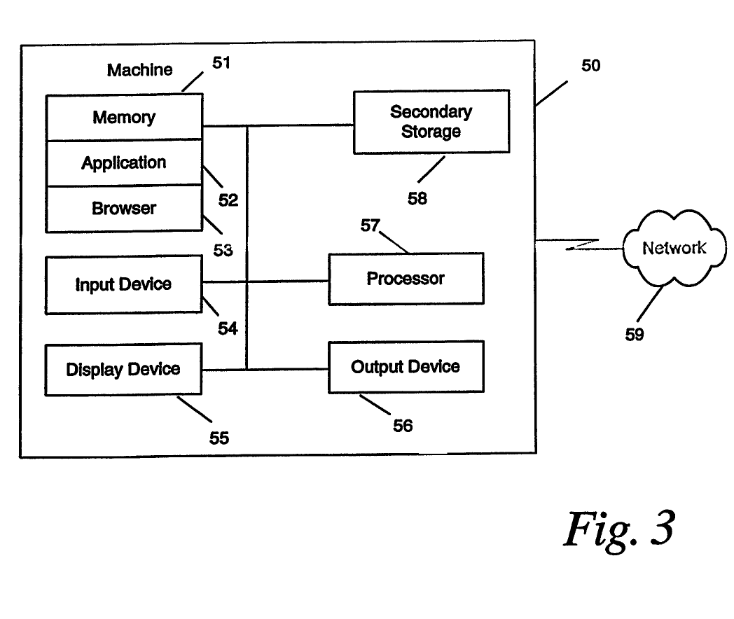

FIG. 3 is a diagram of an exemplary machine 50 for using the navigator. Machine 50 can include a connection with a network 59 such as the Internet, a wide-area network, or a local area network. Machine 50 can retrieve remote content for a channel via network 59 from, for example, web sites, remote servers, remote storage devices, or other machines connected to network 59. Content can also be retrieved locally for a channel. Machine 50 typically includes a memory 51, a secondary storage device 58, a processor 57, an input device 54, a display device 55, and an output device 56.

Memory 51 may include random access memory (RAM) or similar types of memory, and it may store one or more applications 52 and a web browser 53 for execution by processor 57. Applications 52 may correspond with software modules to perform processing for embodiments of the invention. Examples of web browsers include the Internet Explorer program by Microsoft Corp. and the Netscape Navigator program by Netscape Communications, Inc. Web browsers, also referred to as browsers, include any program for retrieving content locally or from a network and displaying it in a structured format such as pages.

Secondary storage device 58 may include a hard disk drive, floppy disk drive, CD-ROM drive, or other types of non-volatile data storage. Processor 57 may execute applications or programs stored in memory 51 or secondary storage 58, or received from the Internet or other network 59. Input device 54 may include any device for entering information into machine 50, such as a keyboard, key pad, cursor-control device, touch-screen (possibly with a stylus), or microphone. Display device 55 may include any type of device for presenting visual information such as, for example, a computer monitor, flat-screen display, or display panel. Output device 56 may include any type of device for presenting a hard copy of information, such as a printer, and other types of output devices include speakers or any device for providing information in audio form. Machine 50 can possibly include multiple input devices, output devices, and display devices.

Example of machines for implementing machine 50 to execute the navigator include the following: personal computers, laptop computers, notebook computers, palm top computers, network computers, Internet appliances, personal digital assistants (PDAs), or any processor-controlled device capable of executing a browser.

Although machine 50 is depicted with various components, one skilled in the art will appreciate that this machine can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). The computer-readable media may include instructions for controlling machine 50 to perform a particular method.

### Navigator Processing

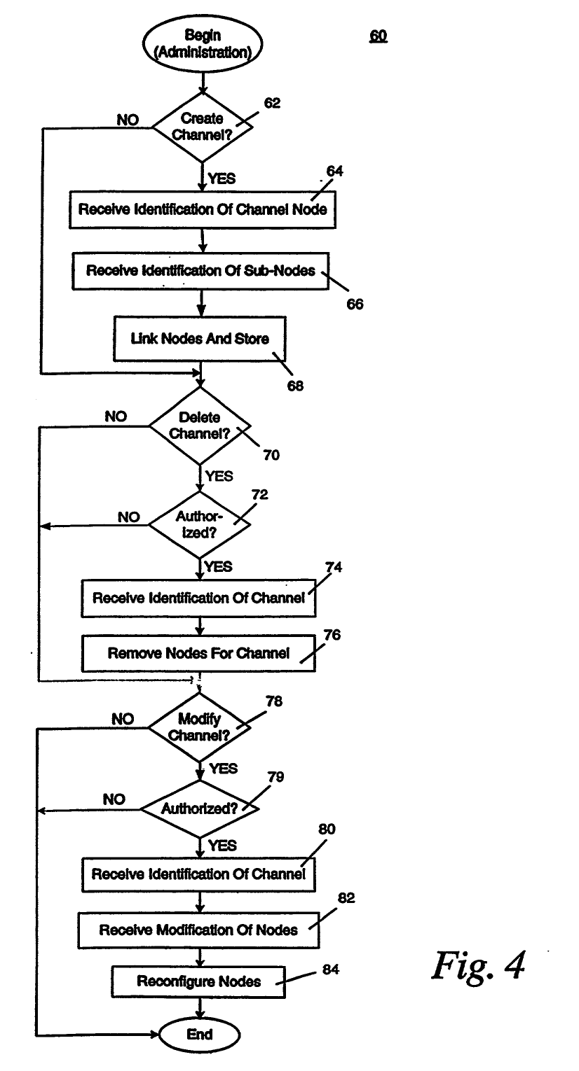

Navigator 12 is typically implemented as a software module wrapper, such as application 52, around browser 14 for intercepting and processing communications to and from the browser. FIG. 4 is a flow chart of an administration routine 60 implemented by navigator 12. Routine 60 is used to perform various administrative functions such as creating or sponsoring a channel, deleting a channel, or modifying a channel. In routine 60, the navigator determines if a user wants to create a channel (step 62); if so, the navigator permits the user to enter an identification of a channel (step 64) and identification of sub-nodes (step 66). The information entered for the nodes can include, for example, the information shown in Appendix A such as node identifiers, page identifiers, and URLs for the nodes and pages. The navigator links the nodes according to a user-specified or default structure and stores the channel (step 68).

The navigator determines if the user wants to delete a channel (step 70). If the user wants to delete a channel, the navigator can determine if the user is authorized (step 72). For example, a user can be authorized to delete only those channels that the user has created. If the user is authorized, the navigator receives an identification of a channel (step 74) and removes the nodes for the channel (step 76).

The navigator also determines if the user wants to modify a channel (step 78). If so, the navigator can determine if the user is authorized to modify the channel (step 79). For example, the user can be authorized to modify only those channels that the user has created. If the user is authorized, the navigator receives an identification of a channel (step 80) and a modification of the nodes for the channel (step 82). The modification can include any change to the channel such as the user adding nodes or sub-nodes, deleting nodes, changing the hierarchical relationships between nodes, or adding or changing URLs for the nodes or pages. The user can enter the exemplary information shown in Appendix A for the modifications. Based upon the information entered for modification, the navigator reconfigures the nodes for the channel (step 84).

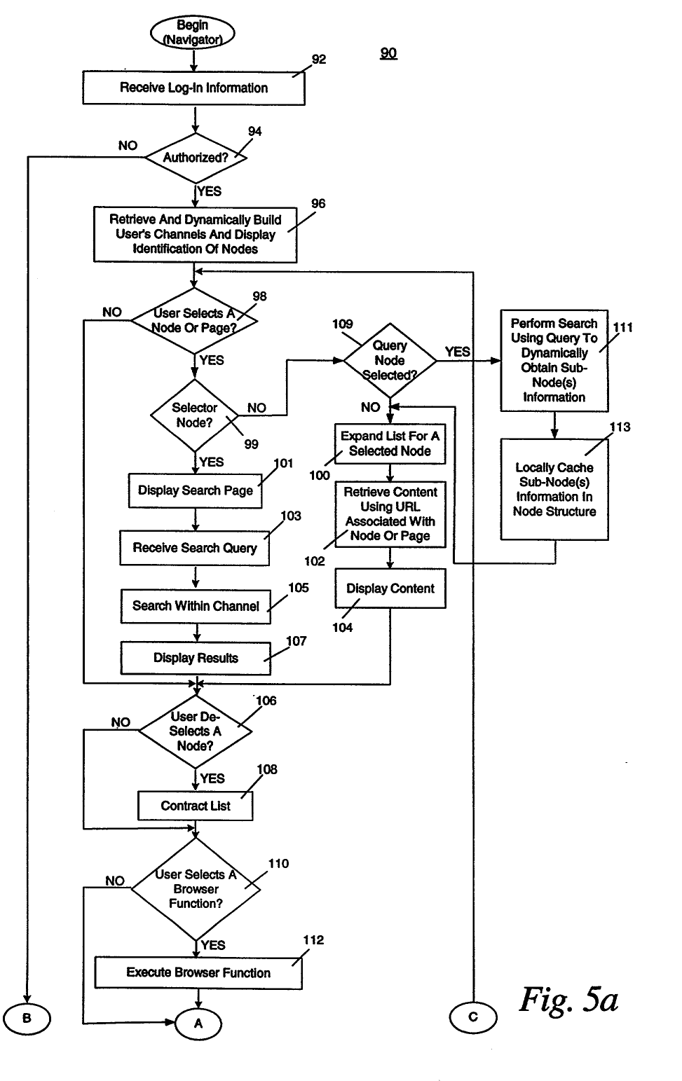

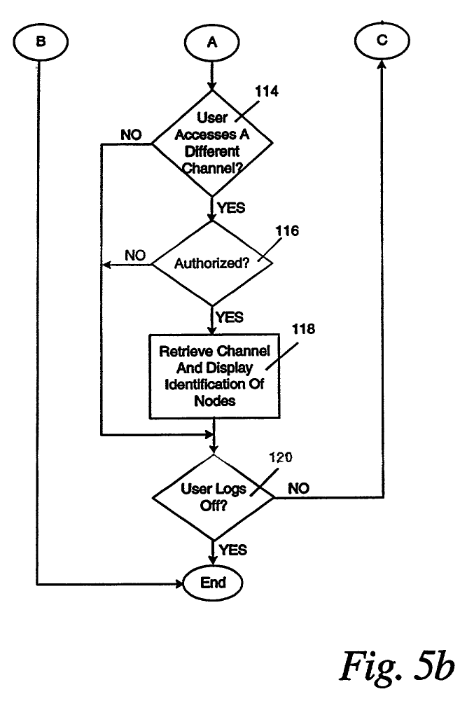

FIGS. 5a and 5b is a flow chart of a navigator routine 90, implemented by navigator 12 and permitting a user to access content through channels and perform browser functions. In routine 90, the navigator receives log in information from a user (step 92) and determines if the user is authorized (step 94). The navigator can require that a user enter a user identifier and password, and it can maintain a database of user identifications and corresponding passwords to authenticate users. If the user is authorized, the navigator retrieves the user's channel and displays an identification of nodes (step 96). The navigator can link the user identification with the user's channel in order to retrieve the channel based upon the user's log in information. The user's channel includes an identification of the nodes and linking between them as illustrated in FIG. 2.

The navigator can thus define a separate collection and linking of nodes for each channel, and assign users to channels. Since each node can contain a URL or pointer to content, the content need only be stored in one location, for example, and the navigator can dynamically retrieve and build a particular channel based upon its node structure and specified URLs. Also, the content can be updated at its stored location, and the navigator can therefore retrieve the most current content using the URLs to locate it. Each user can also define or sponsor their own channel and, by determining which nodes to include in their channel, the users can in effect limit access to only the content referenced by those nodes. If a user has access to a particular node, then the user also has access to all sub-nodes in this example.

Table 1 illustrates how the navigator can maintain a database associating a user's identifiers and passwords, or other unique authentication information, (the log in information) with the user's authorized channels for displaying an identification of those channels. As indicated above, using data doubles the user can have multiple on-line identities each linked with potentially a different collection of channels.

TABLE 1

| user identity | password | user's authorized |
|---|---|---|
| | | channels |
| identifier 1 | password 1 | channel 1 |
| | | channel 2 |
| | | . . . |
| | | channel N |
| . . . | | |
| identifier N | password N | channel 1a |
| | | channel 2a |
| | | . . . |
| | | channel Na |

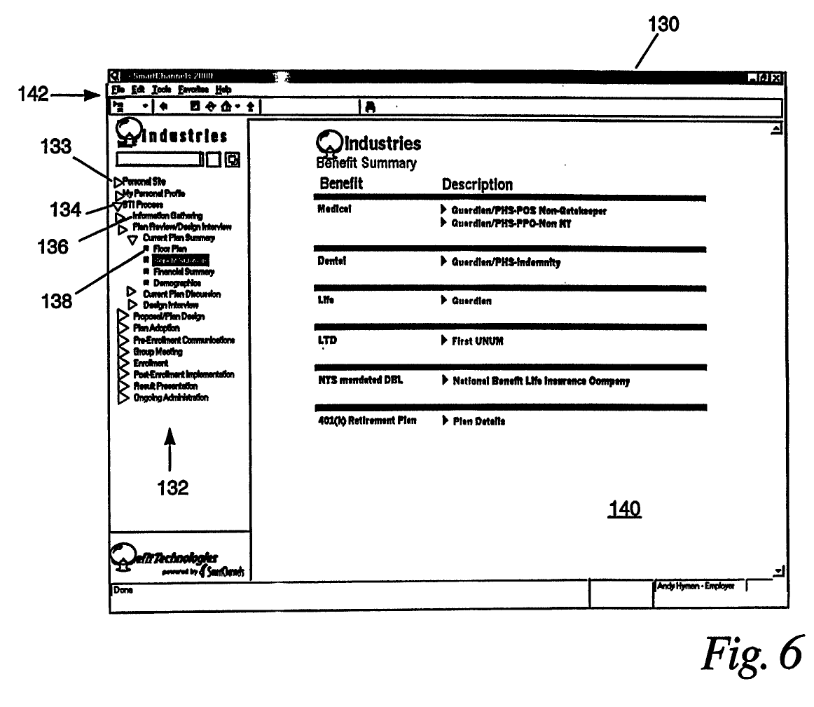

FIG. 6 is a screen 130 illustrating display of a user's channels for step 96. Screen 130 can be formatted, for example, in HTML for display as a web page by the browser on display device 55. Screen 130 includes a navigator section 132 for displaying an identification of the nodes for the user's channel. The user's personal site is represented by a node 133 for the user's channel. This example includes other channels such as a node 134 for a BTI process, which can represent a channel sponsored by the user's employer for providing employment-related information to the user. BTI process node 134 includes sub-nodes as represented by the indentation such as an information gathering node 136. In the displayed structure of a channel, the triangle symbols represent nodes and the square symbols represent pages. Other types of symbols can be used. Screen 130 includes a content section 140 for displaying content in pages as selected in navigator section 132. It also includes a toolbar 142 for identifying context-sensitive actions and conventional browser-type functions.

After displaying screen 130 for the user's channels, the navigator detects if the user selects a node or page in navigator section 132 (step 98). The user can make the selection by using, for example, a cursor-control device to “click on” the symbol for the node or page. The navigator determines if the selected node is a selector node, used for searching within the channel (step 99). If the user selected a selected node, the navigator displays a search page (step 101) and receives a search query entered through the page (step 103). The navigator searches within the content of the channel for the search query (step 105) and displays results of the searching (step 107). Any type of search engine can be used for searching the channel content. This feature provides a user with a method of performing a focused search, as the search occurs within the structured content of the channel.

For other selected nodes, the navigator expands the list in navigator section 132 to display the sub-nodes (step 100). It can expand the list statically or dynamically. For static expansion, the navigator can use the associated sub-nodes as illustrated in FIG. 2 for a particular node structure. For dynamic expansion, the navigator can dynamically retrieve information for sub-nodes based upon a search query. In particular, the navigator determines if the selected node is a query node (step 109). The term “query node” is used only as a label to refer to a node having dynamically configured sub-nodes. The navigator can determine if the selected node is a query node by, for example, inspecting its properties to determine if it has an associated search query for its sub-nodes. Based upon the search query, the navigator performs a search to obtain sub-node information, which includes any data or information for specifying the sub-nodes such as URLs, pointers, or other identifiers. The search can be performed, for example, within the user's node structure or in any network-accessible location such as in channels or even in local areas such as a user's local storage. The search query can optionally specify a particular location, such as a database, in which to search for matches to the query and can optionally specify fields of objects or nodes in which to perform the search. It can also optionally include Boolean operations.

Therefore, as an example, a query node may specify, through its properties, sub-nodes retrieved using the following query structure: select sub-nodes from [location] where [field of object or node] like [search term or terms with optional Boolean operations]. Upon retrieving information, if any, for the sub-nodes, the navigator locally caches it within the user's node structure (step 113) and expands the list using the retrieved sub-node information (step 100). A query node can thus be used, for example, to dynamically modify a user's node structure. A user may wish, for example, to view all nodes created within a particular time frame or all nodes having a particular title, and users can create a suitable search query in the properties for a query node to obtain that information upon selection and expansion of the query node.

As further sub-nodes are selected, the navigator continues to expand the list to show the channel structure. For a selected page within navigator section 132, the navigator retrieves content using a URL associated with the node (step 102) and displays it in content section 140 (step 104). The information can be retrieved over the Internet using the URL, from another type of network, or locally on the user's machine. The URL represents a pointer to the content, which can be modified or updated. The navigator can thus obtain the most current content by retrieving it upon selection of a page. Instead of URLs, other types of pointers or identifiers can be used to access or identify a location of content.

The navigator determines if the user de-selects a node (step 106). A user de-selects a node by, for example, using a cursor-control device to “click on” a node that has been expanded. Upon detecting the de-selection, the navigator contracts the displayed list of sub-nodes for that node (step 108).

The navigator determines if the user selects a browser function (step 110). The user can select a browser function by, for example, using a cursor-control device to “click on” one of the symbols in toolbar 142. The browser functions can include conventional browser functions such as a back command, forward command, refresh command, home command, a list of “favorite” sites, or a search command. Upon selection of a browser command, the navigator passes the command along to the browser for it to execute the command (step 112).

The user can possibly attempt to access other channels (step 114). For example, the user can enter new log in or user identification information. If the user attempts to access other channels, the navigator determines if the user is authorized (step 116) and, if authorized, the navigator retrieves the new channel information and displays nodes for it (step 118). The navigator can continue to execute functions based upon commands entered by the user until the user logs off (step 120).

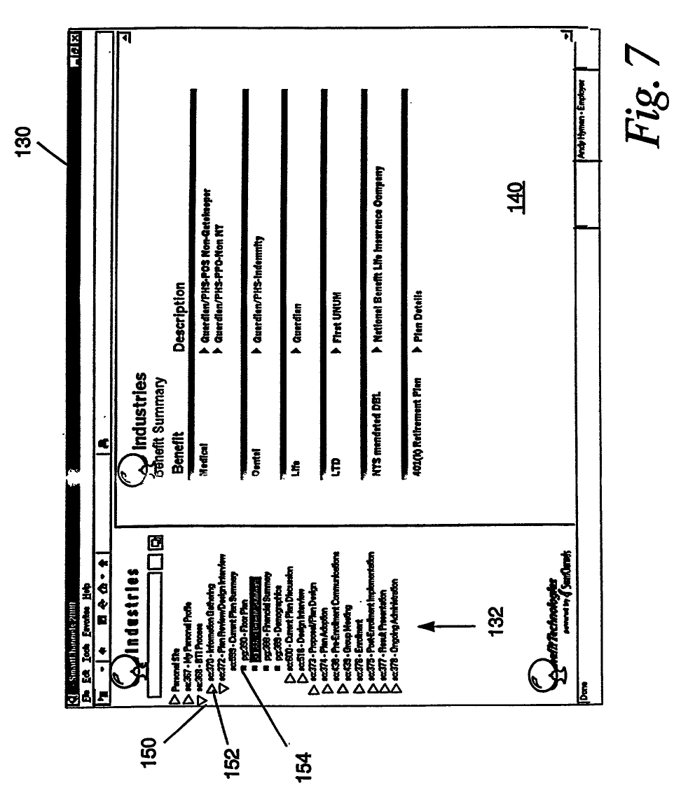

FIG. 7 illustrates in screen 130 node identifiers associated with the nodes for selection. This screen can be displayed, for example, to a database administrator or other person authorized to view it. As further shown in Appendix A, the node identifiers are used to create the links between nodes and sub-nodes, and between nodes and pages, for configuring channels. The nodes in this example include site area (sa) nodes such as node 150; section (sc) nodes such as node 152; and page (pg) nodes such as node 154. Other types of nodes include user group (ug) nodes and selector (mg) nodes, as identified in Appendix A. Site area and section nodes identify context, page nodes identify content, and user group nodes identify particular user groups. Selector nodes, as explained above, are used for searching within a channel. These labels for the nodes are one example of classifying nodes, and different labels and classifications can be used.

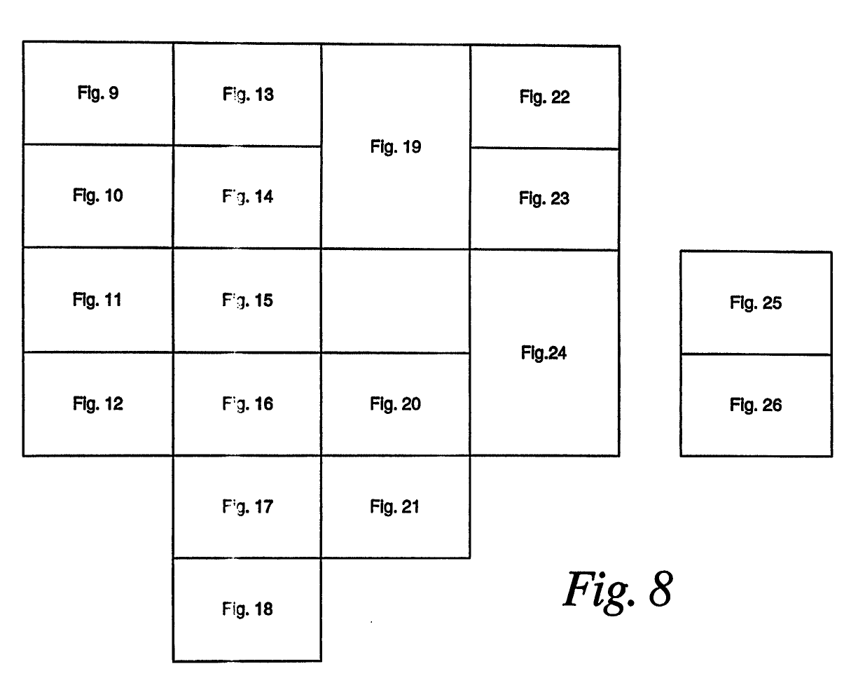

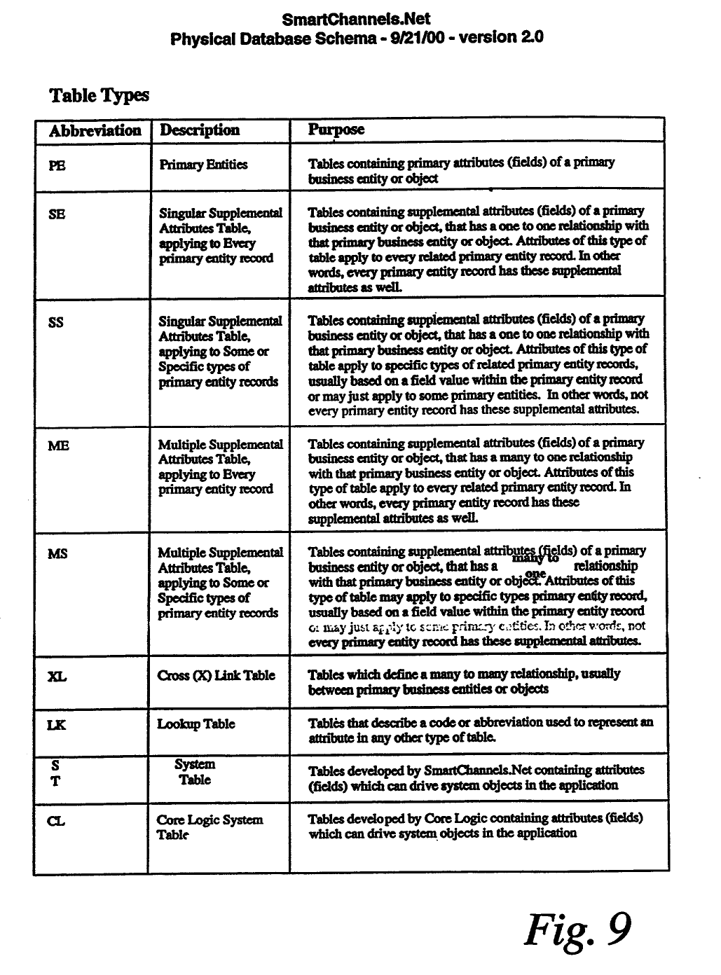

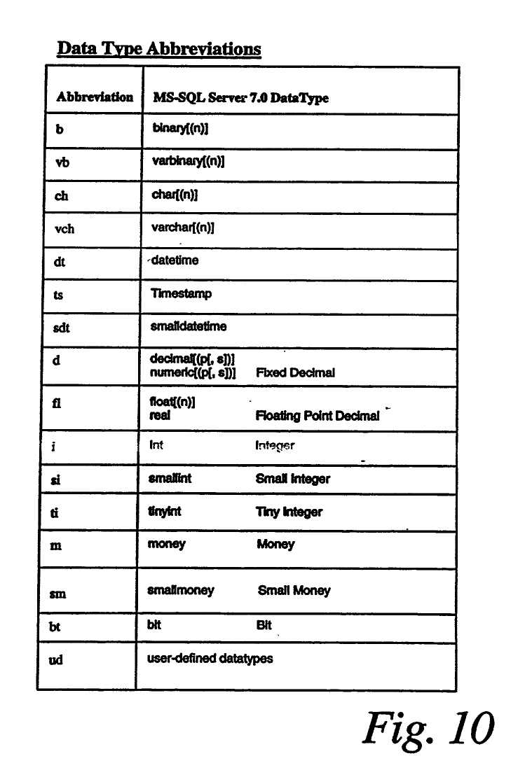

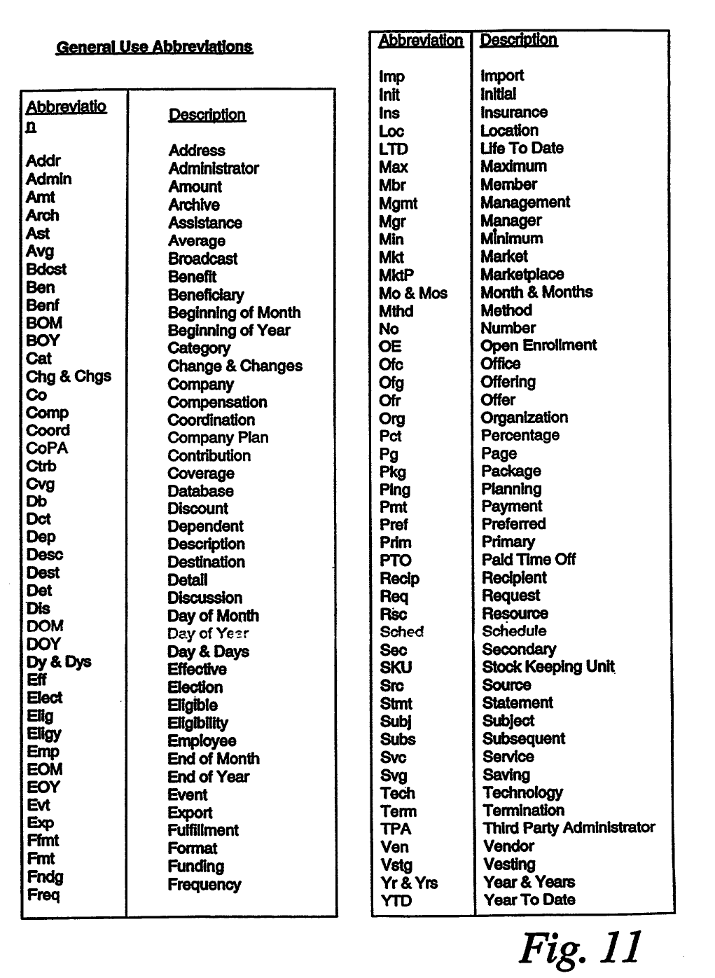

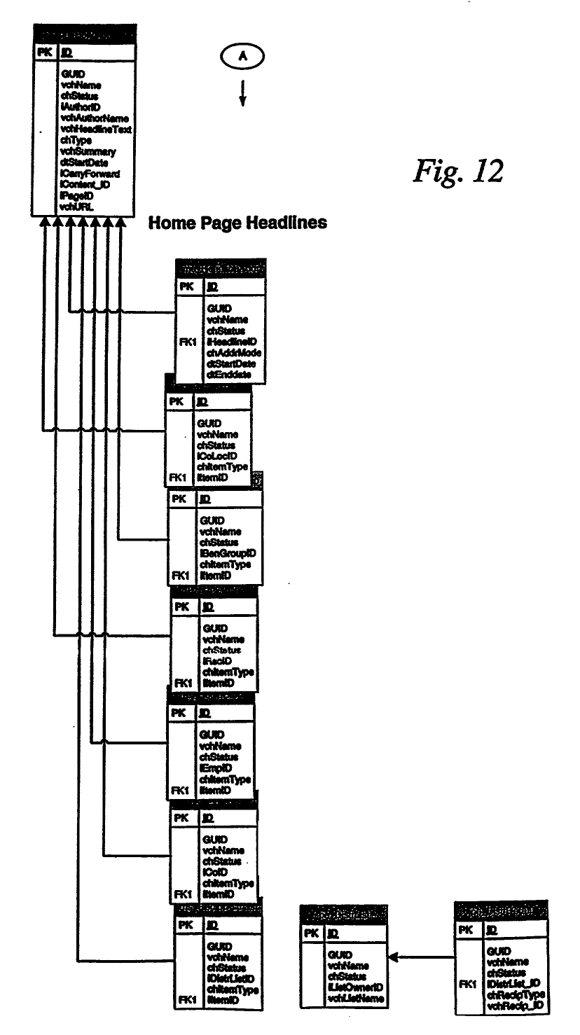

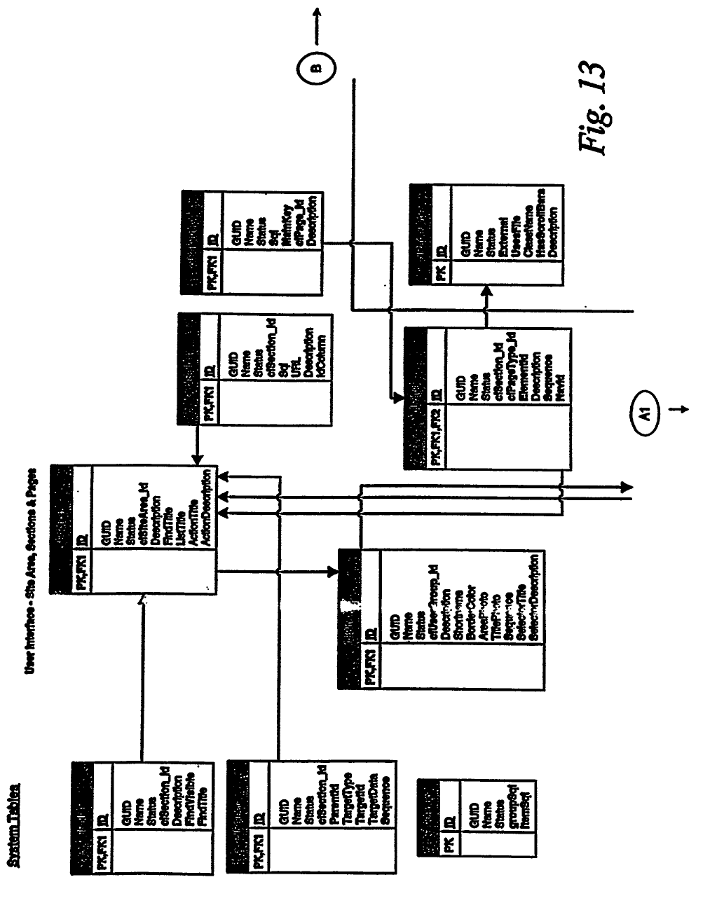

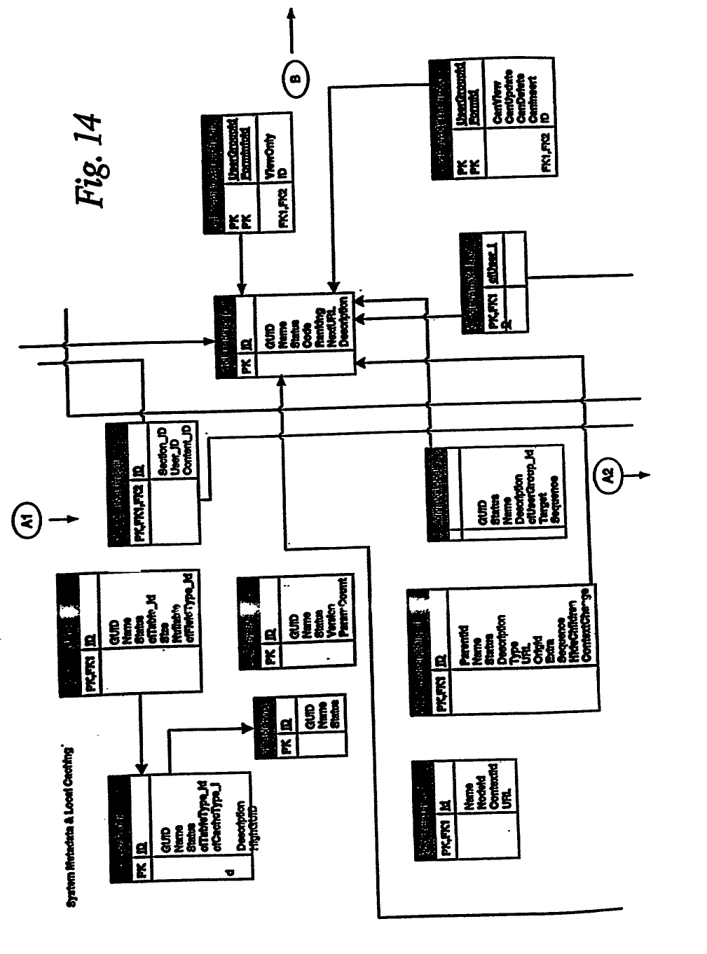

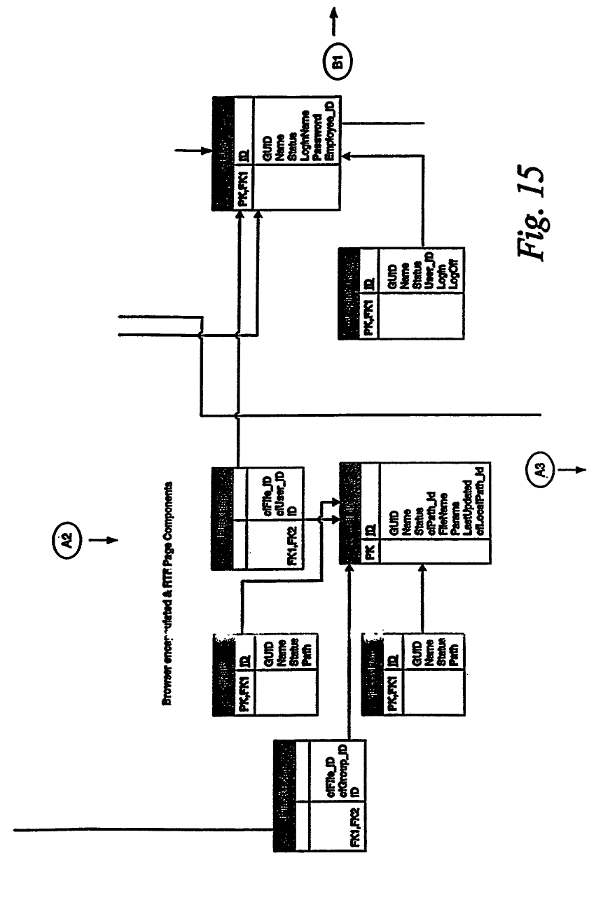

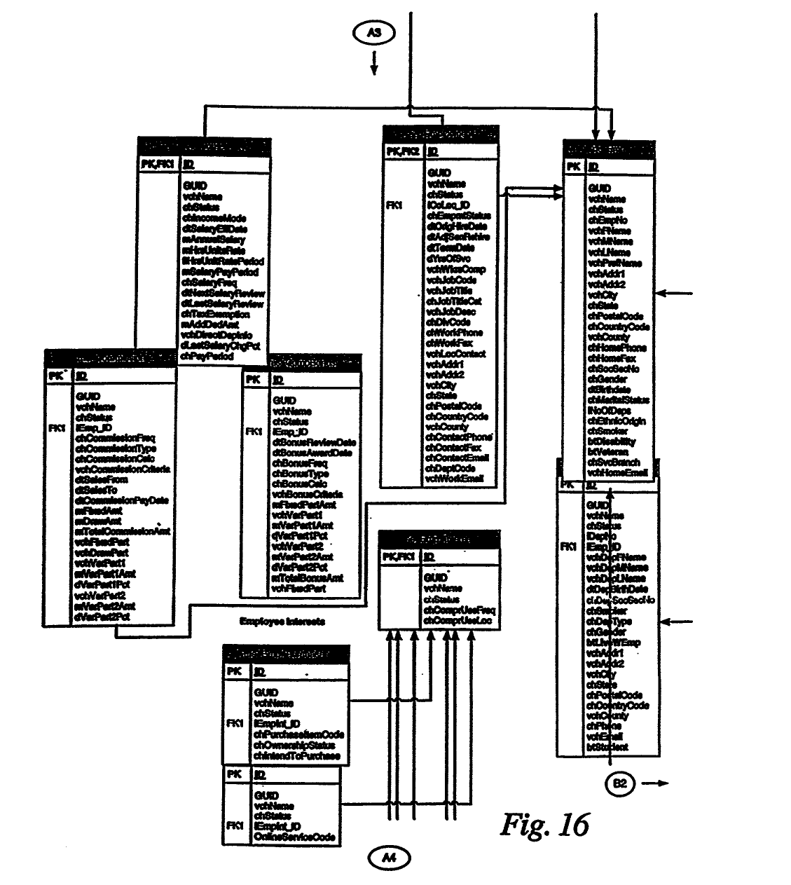

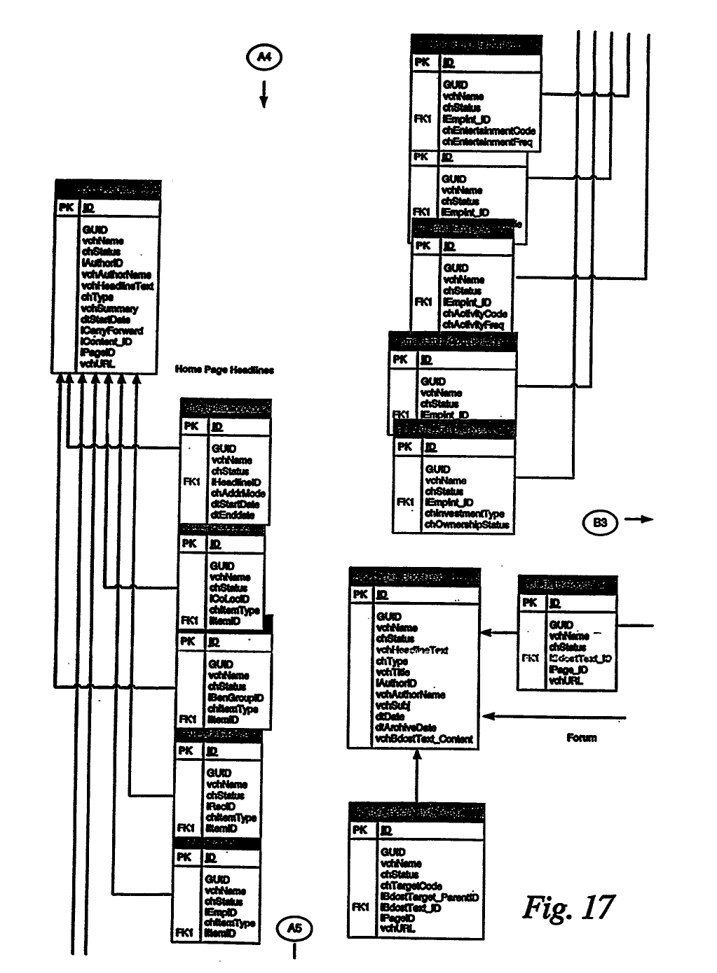

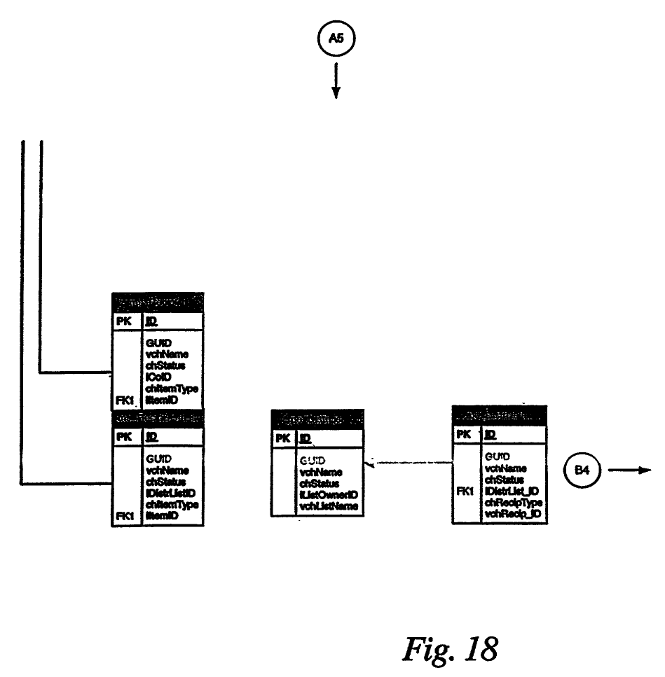

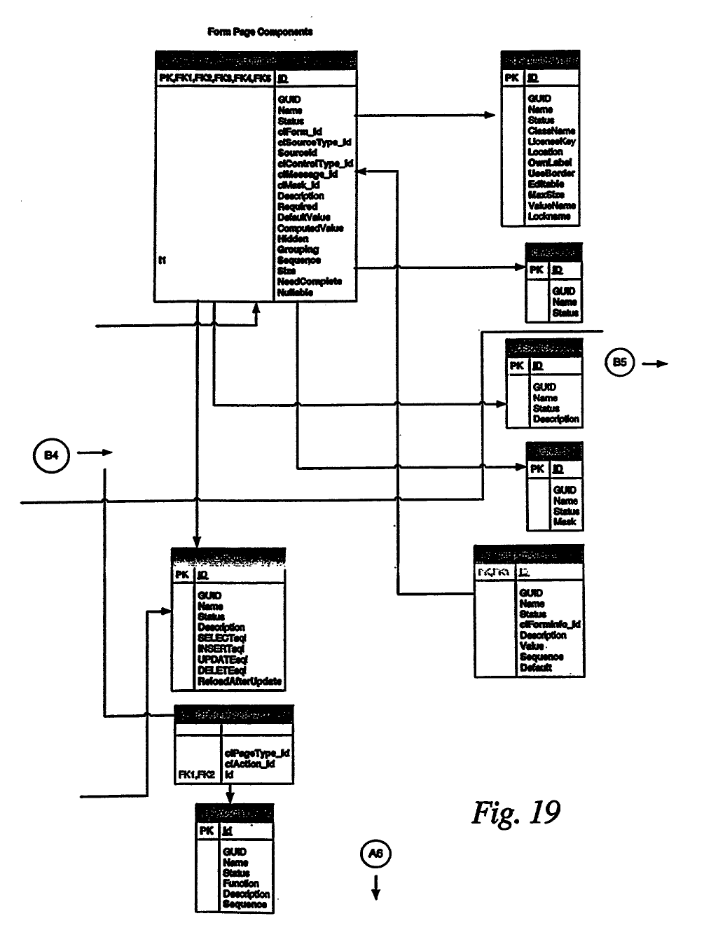

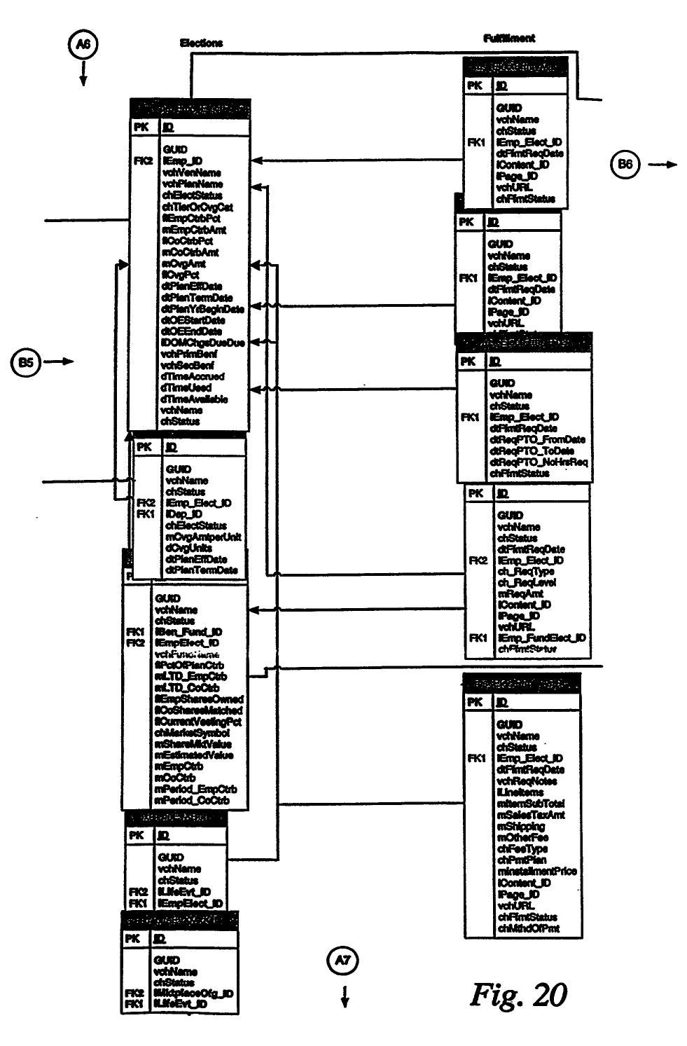

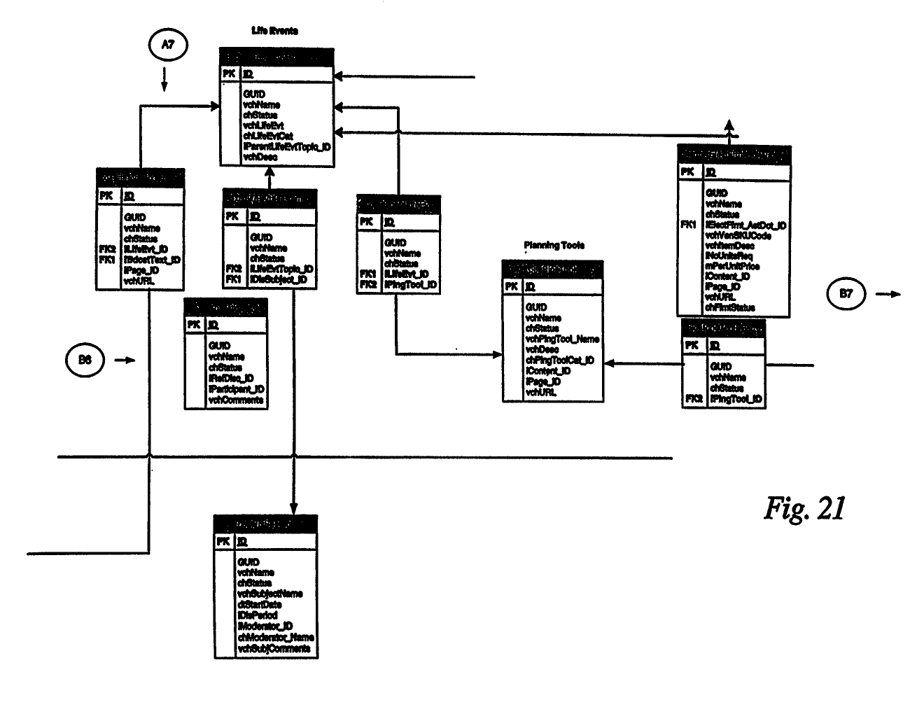

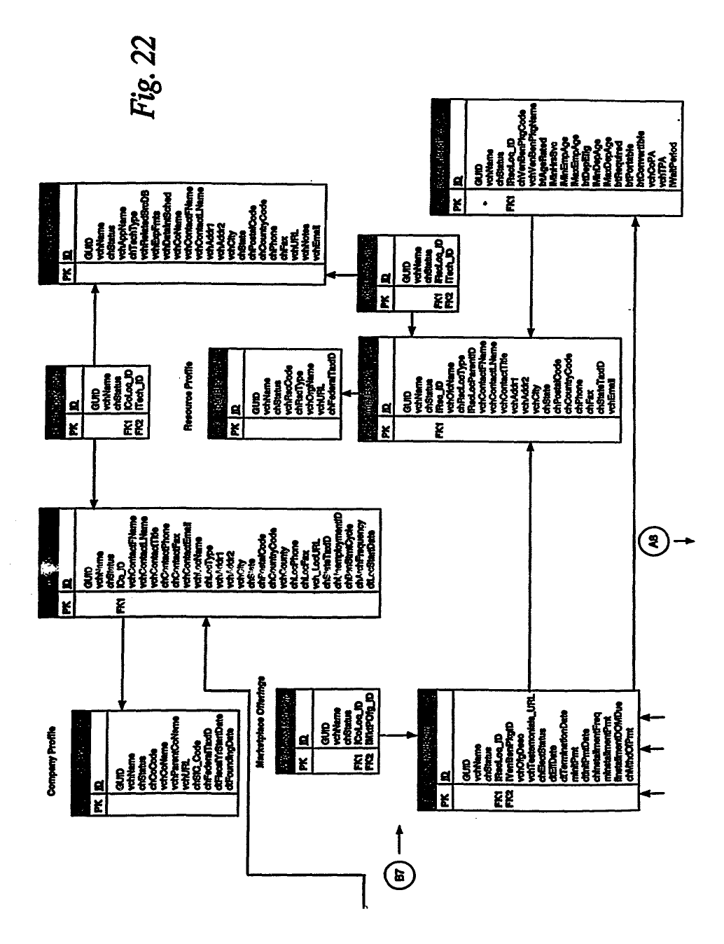

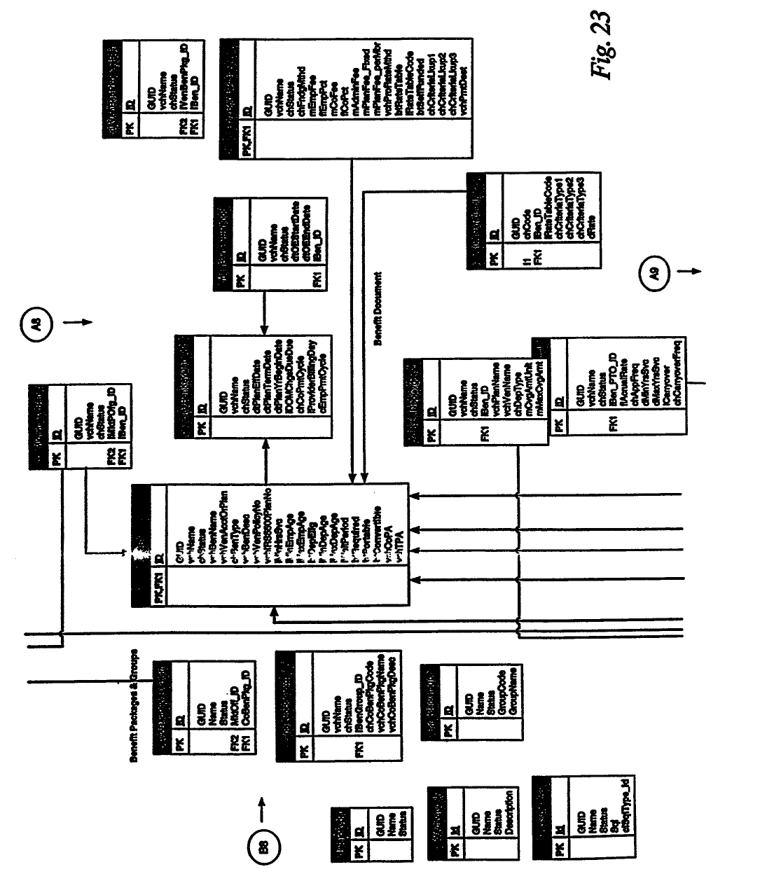

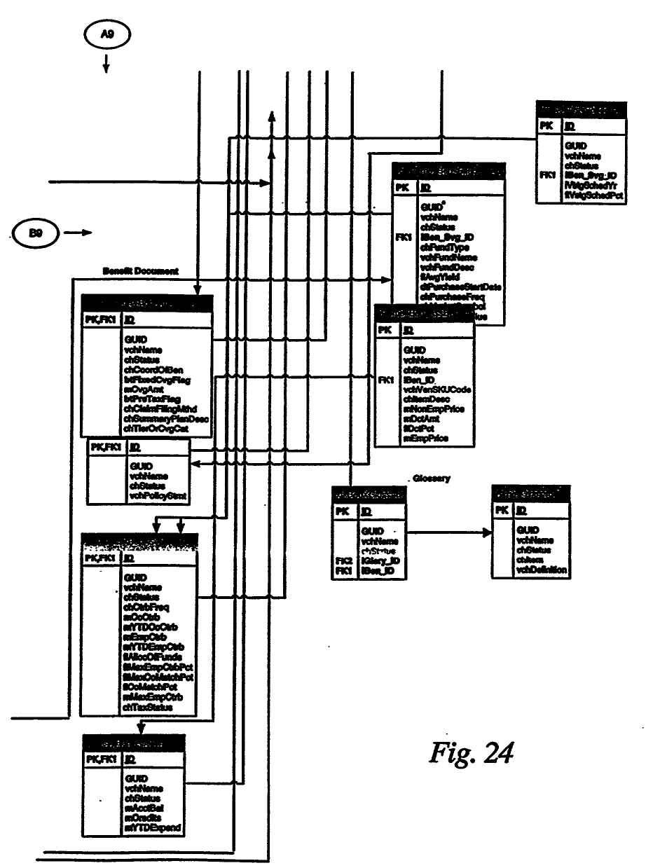

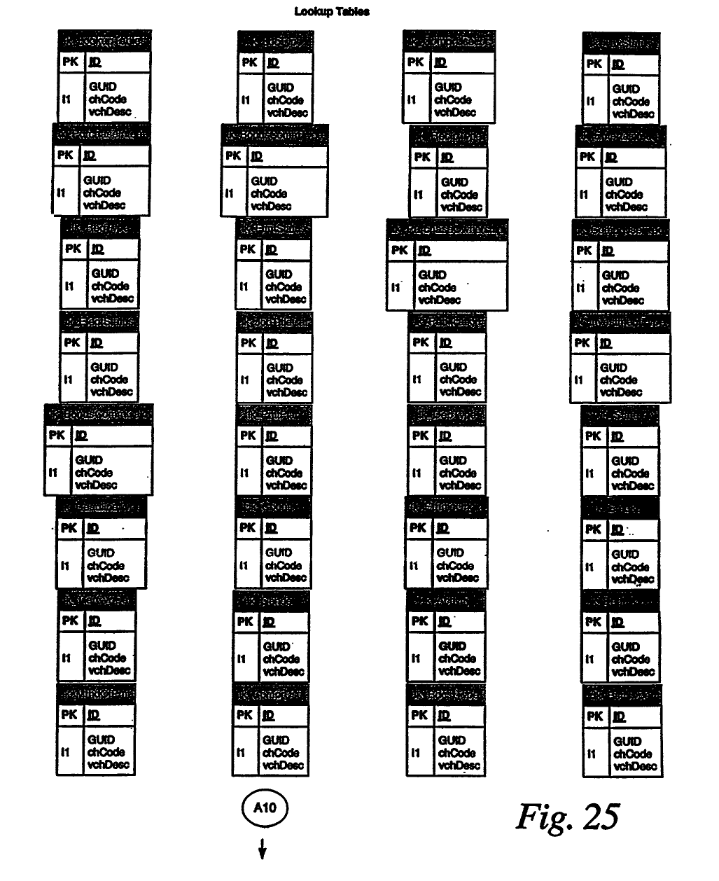

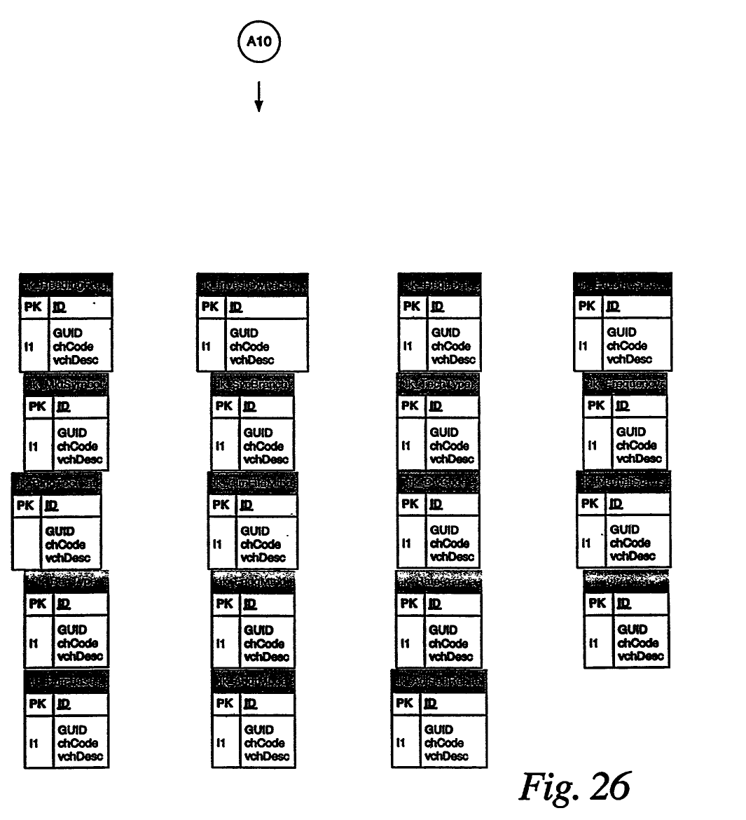

Each channel typically has its own database schema, and FIGS. 8-26 are diagrams of an exemplary database schema for implementing a channel. This schema can be repeated for additional channels. In FIGS. 8-26, FIG. 8 illustrates how FIGS. 9-26 fit together in order to collectively illustrate the exemplary database schema.

### Dynamic Configuration of Node Structure for User Site

The selection navigator allows users to dynamically configure the node structures for their sites and in effect publish content to user groups. A “drag and drop” feature allows a user to insert nodes and reconfigure a node structure using, for example, a cursor control device to move selected items into the node structure. Master nodes and master structures allow a user to, for example, publish content to a wide variety of users and user groups by copying the master node into the user and user group nodes. The copies are linked to the user (publisher's) master node, meaning that the user need only make changes to the master node, and those changes are automatically propagated to the subscribed users and user groups. Custom nodes allow users to configure fields and properties for nodes according to their own requirements or desires. The custom nodes can thus be tailored to particular applications of node structures for managing content.

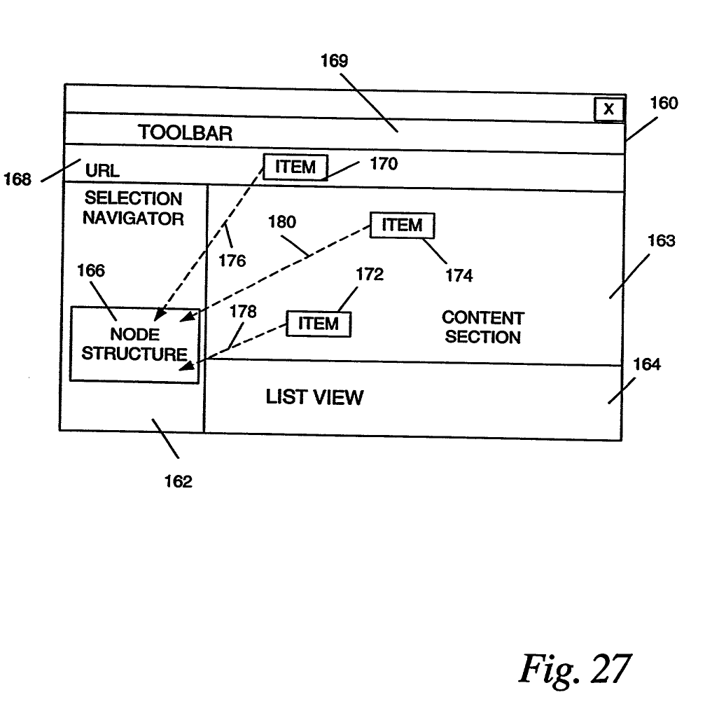

FIG. 27 is a diagram illustrating a “drag and drop” feature to dynamically configure a node structure for a user's site. The phrase “drag drop” is used with reference to a cursor-control device; however, the drag and drop feature is intended to include any way to select and move an item on a display device. A screen 160 illustrates the use of the selection navigator in combination with a web browser. A selection navigator section 162 displays a representation of a node structure 166 for the user's site, as discussed above. Within the displayed node structure, as illustrated in FIGS. 6 and 7, a user can select and expand nodes and channels. A content section 163 displays content for the selected nodes or other items. Each node is typically associated with a particular network address or URL, which is used by the browser to obtain and display the corresponding content, possibly including locally stored or remotely stored content. A toolbar 169 displays sections for a user to select commands such as typical browser commands; for example, forward, back, refresh, and home commands. A URL section 168 displays a URL corresponding with selected content in section 163. A section 164 can display a list view of a selected node, such as displaying fields for a name, description, and location for the corresponding node. Screen 160, and the exemplary screens described above, illustrate one particular arrangement of sections 162, 163, and 164; other arrangements are possible.

Screen 160 illustrates how a user can dynamically configure or modify the node structure 166 for the user's site by dragging and dropping, or otherwise moving, items into the displayed representation of the node structure. For example, a user can select an item 170, such as URL, and drag and drop it into node structure 166, as represented by line 176. Likewise, a user can select items 172 and 174, such as content associated with URLs, in section 163, and drag and drop them into node structure 166, as represented by lines 178 and 180. Dragging and dropping can be accomplished using a cursor-control device to select (“click on”) the item and move it to a location in the node structure 166. For example, a user “clicks on” the item using a button on the cursor-control device and, while continuing to depress the button, moves (“drags”) the item to a new location using the cursor-control device. The user then releases the button in order to “drop” a copy of the item in the new location. The user drops the item in the node structure 166 at the location of a particular node or sub-node (see FIG. 2) and the item becomes associated with that node and a part of the node structure.

In this manner, the user can dynamically and easily add items to the node structure for the user's site and reconfigure the structure in a user-friendly way. As an alternative to dragging and dropping items using a cursor-control device, other ways are possible through input of other commands such as key strokes, voice commands, or a touch screen. As described below, the selection navigator can track cursor position in order to detect items selected and a location to insert them in the node structure 166.

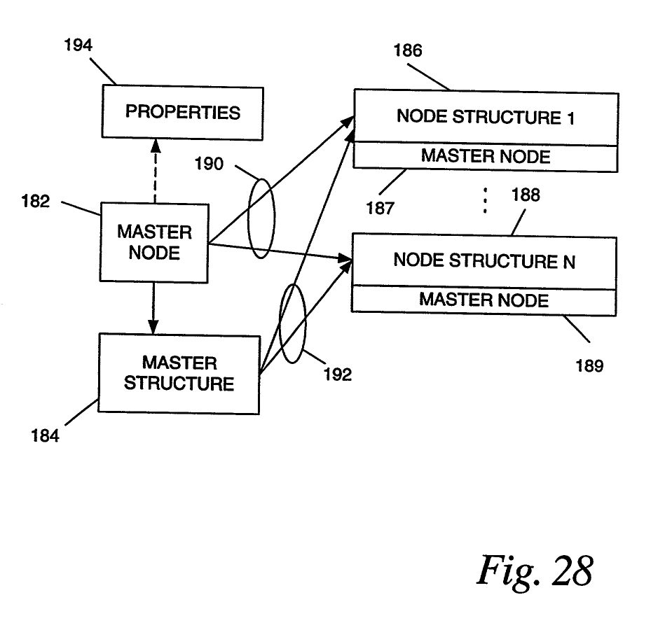

FIG. 28 is a diagram illustrating configuration of the master nodes. Certain nodes within a user's site can be classified as master nodes for the user to publish content to user groups, for example. A master node 182 includes an associated master structure 184, which specifies the collection of nodes such as sub-nodes and their relationships for the master node; a master node can possibly have no sub-nodes or any number and configuration of sub-nodes. Each master node 182 is associated with properties 194, as explained below, for use in specifying or associating content and other information with the master node. The master node 182 can be copied into, and thus associated with, one or more other node structures as shown by master nodes 187 and 189 in node structures 186 and 188; for example, master node 182 can be copied into various user groups. Master nodes 187 and 189 inherit the properties of master node 182. Therefore, master nodes propagate content to user groups and master structures propagate structures of nodes to user groups.

Master node 182 and master structure 184 are linked with the corresponding node structures 186 and 188, as represented by lines 190 and 192. Therefore, any changes in master node 182, such as changes in its properties, and changes in master structure 184 for it, are automatically propagated to node structures 186 and 188 linked with them. Therefore, master node 182 allows a user to publish content to a wide variety of user groups and easily change the published content by simply making changes to master node 182 rather than, for example, having to change the content in each individual user group.

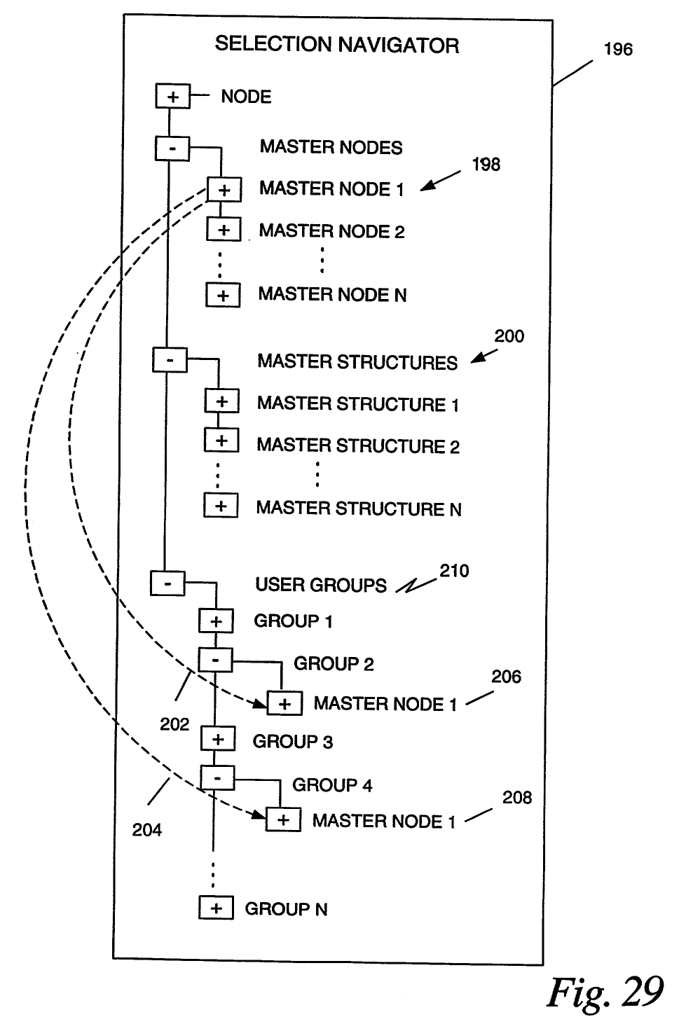

FIG. 29 is a diagram illustrating use of the master nodes. A selection navigator section 196, which corresponds with section 162, displays a representation of a node structure for a user's site. The representation includes one or more master nodes 198 and corresponding master structures 200 for the master nodes. The master nodes 198 and master structures 200 are only displayed to the user controlling them for use in publishing content. For example, they can possibly be displayed to an administrator or other authorized person. The selection navigator 196 also displays nodes for one or more user groups 210. The user can include master nodes in the user groups by dragging and dropping them, as described above and represented by lines 202 and 204, to the displayed nodes for the groups. For example, master node 1 has been copied to user groups 2 and 4 as shown by master nodes 206 and 208. If the user makes changes to master node 1, or master structure 1 for it, those changes are automatically propagated to master nodes 206 and 208 in user groups 2 and 4. The user can drag and drop, or otherwise include, master nodes in any number of user groups, and selection navigator 196 shows only one such example for illustrative purposes only.

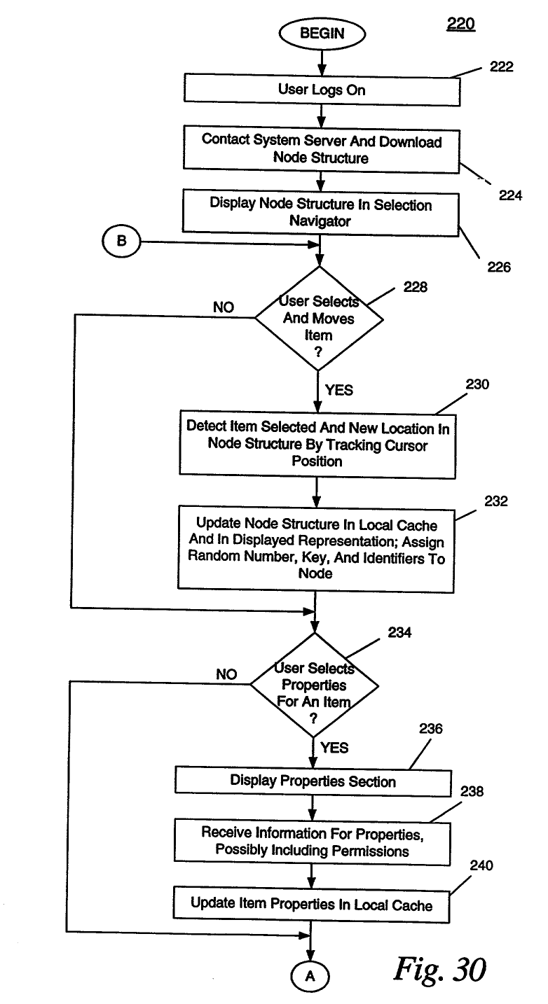

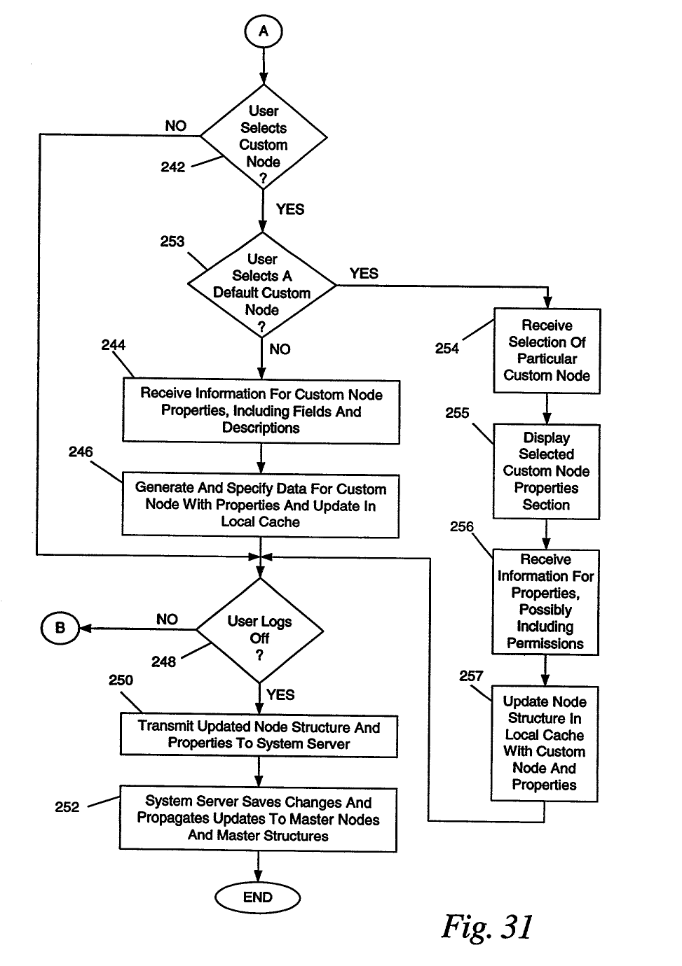

FIGS. 30 and 31 are a flow chart of a method 220 for dynamic configuration of a node structure for a user's site. The dynamic configuration includes, for example, the drag and drop feature and master nodes described above, as well as custom nodes having user-specified properties and fields. Method 220 can be implemented, for example, in software modules in navigator 14 operating in conjunction with browser 12. In method 220, the selection navigator detects that the user attempts to log on (step 222), which may involve display of a section or window for the user to enter a name and password. If the user successfully logs on, using the appropriate information such as a correct password for the user name, the selection navigator via the browser contacts the system server and downloads the node structure for the user (step 224). The selection navigator typically stores the downloaded node structure in a local cache for the user machine such as in memory 51. This communication can occur over network 59 such as the Internet using a browser. The system server, or other entity, can store the node structure associated with each user name or other identifier and can thus provide the node structure in response to detecting the log on by the user.

The node structure is conceptually illustrated in FIG. 2 and includes the nodes and links between nodes for this user. It can be implemented, for example, with a set of linked URLs and associated properties establishing the hierarchical relationships among nodes. The selection navigator displays a representation of the node structure such as is shown in section 162 (step 226). This representation can be implemented, for example, using icons to represent nodes, lines connecting the icons to represent links between them, and indentation to represent hierarchical levels among the nodes. An example of a representation is shown in FIGS. 6, 7, and 29. Alternatively, any visual representation can be used.

The selection navigator detects whether the user selects and moves an item (step 228). By tracking cursor position, the selection navigator can detect the particular displayed item selected and a new location for it in the node structure, if dropped within the node structure (step 230). This step can involve detecting the dragging and dropping of items as explained above. Methods for tracking cursor position are known in the art and can be implemented, for example, in software as part of the selection navigator or in the software the drives and receives signals from the corresponding cursor control device.

An item can include, for example, a node, a custom node (explained below), a URL, a network address, a pointer, or any particular content. It can also include a master node moved (copied) to another part of the node structure to link the master node with a user group, for example. The content for items can include, for example, text files, graphics, pictures such as JPEG files, video such as MPEG files, audio files, or multimedia information. Upon detecting the new location for the selected item in the node structure, the selection navigator updates the node structure in a local cache, such as in memory 51, for the user's machine and updates the displayed representation of the node structure in section 162 (step 232). Since the selection navigator preferably stores the downloaded node structure in the local cache, it can make changes to the node structure locally without having to contact the system server for each change.

As part of the update to the node structure in the local cache, the selection navigator, for example, assigns to the inserted item a random number and a key having identifiers. The key can include, for example, a four-level key having a channel identifier, a group identifier, a node identifier, and an extra identifier. The channel and group identifiers can specify, respectively, the channel and user group into which the item is inserted in the node structure. The node identifier can include identifiers specifying a channel and type for the node and a unique identifier for it. The node identifier also can include a URL string specifying full path for node or other item including all parent nodes; the key can thus be selected based upon an inserted location for the node by specifying its full address path. Table 2 illustrates how URLs, for example, can be used to specify the full path and also used to help create the hierarchical structure for the various channels, user groups, nodes, and sub-nodes. The exemplary structure in Table 2 is provided for illustrative purposes only. Also, as explained below, each node can be associated with properties, such as a URL or descriptor, for linking the node or other item to content.

TABLE 2
Node Structure for User X

http://user-x-home/channel-1/user-group-1/node-1
http://user-x-home/channel-1/user-group-1/node-1/sub-node-1
http://user-x-home/channel-1/user-group-1/node-1/sub-node-2
http://user-x-home/channel-1/user-group-1/node-1/sub-node-2/sub-node-2a
http://user-x-home/channel-1/user-group-2/node-1/sub-node-1
http://user-x-home/channel-2/user-group-1/node-1
. . .

The key and identifiers can be implemented using, for example, numbers or alphanumeric strings. Also, by detecting a dropped location of the item in the node structure, the selection navigator can link the item with a parent item or node in the hierarchical structure (see FIG. 2) in order to incorporate the item and specify its full address path.

Therefore, by knowing a location of a selected item, either locally or remotely, the selection navigator can generate a link to the item in the updated node structure. For example, if the item constitutes content available via the Internet, the selection navigator can detect a URL for the site and location of the content (for example, http:H/www.website.com/page1) and associate that URL at the location where the item was inserted in the node structure. Likewise, if the selected item constitutes local content, the selection navigator can detect a stored location of it (for example, c:/my files/file1) and associate that location with the inserted item in the node structure. This information constitutes properties associated with the item, as further explained below.

The following provides an example of an actual implementation for the keying in step 232. The keying includes a NodeKey structure, which is made up of the following, for example: NodeType; ChannelId; Id; Extra; Extra2; bValid; and NodeType. NodeType an enumeration of the different kinds of node types, which can include a modifiable list.

The following provides an example of 35 locally defined node types: ntUnknown=0; ntTop=1; ntChannel=2; ntUserManager=3; ntUser=4; ntUserGroup=5; ntbranch=6; ntLeaf=7; ntMessage=8; ntweb=9; ntOther=10; ntUserChannel=11; ntUserChannelUserGroup=12; ntFavorite=13; ntQuery=14; ntQueryResult=15; ntXML=16; ntXMLNodes=17; ntChannelObjects=18; ntCustomNodeManager=19; ntStructureManager=20; ntNodeManager=21; ntStructure=22; ntCustomNode=23; ntNode=24; ntChannelUserManager=25; ntChannelUser=26; ntChannelUG=27; ntChannelUserManagerByName=28; ntChannelUserManagerByGroup=29; ntChannelUserManagerlnvite=30; ntChannelInvitedUser=31; ntCustomListManager=32; ntCustomList=33; and ntCustomListColumn=34. In addition, custom node types are defined as 1000 or over, and are totally channel dependent.

An exemplary ChannelId is implemented with 32-bit (4-byte) numbers ranging in value from −2,147,483,648 to 2,147,483,647. This number determines which channel a node belongs to. Each channel is assigned a unique Id upon creation. An exemplary Id is implemented with 32-bit (4-byte) numbers ranging in value from −2,147,483,648 to 2,147,483,647. This Id number is usually the primary key for the record in the table associated with the node type.

The exemplary Extra and Extra2 node types are used for some node types that are more complex and require more tables than usual, or do not have a unifying table. They are variants, which can hold almost any kind of data. The exemplary bValid node type is set when a node structure is created, and it returns whether the node is valid or not.

As for the random key generation, when the selection navigator program starts, the built-in randomizer in the Windows application, for example, is initialized using the system timer, then a function called GetUnique is passed the initial node structure of the key. The function then randomly generates a number, combines it with the initial node structure, and ensures that the key is unique within the tree for the node structure; if not, it will try again until it is unique. Once the record is saved, that temporary key is replaced with the proper, permanent key.

Returning to method 220, the selection navigator also detects whether the user selects properties for an item (step 234). In order to view properties for a particular item such as a node, the can “right click” on the item, for example, using a cursor control device, which causes display of a section or screen detailing properties for the item, or display of a section including a properties descriptor for selection in order to view the properties. Properties can alternatively be viewed in other ways or through entry of other types of commands. Each node and other item can be associated with particular properties for use in the dynamic configuration and control of the user's node structure.

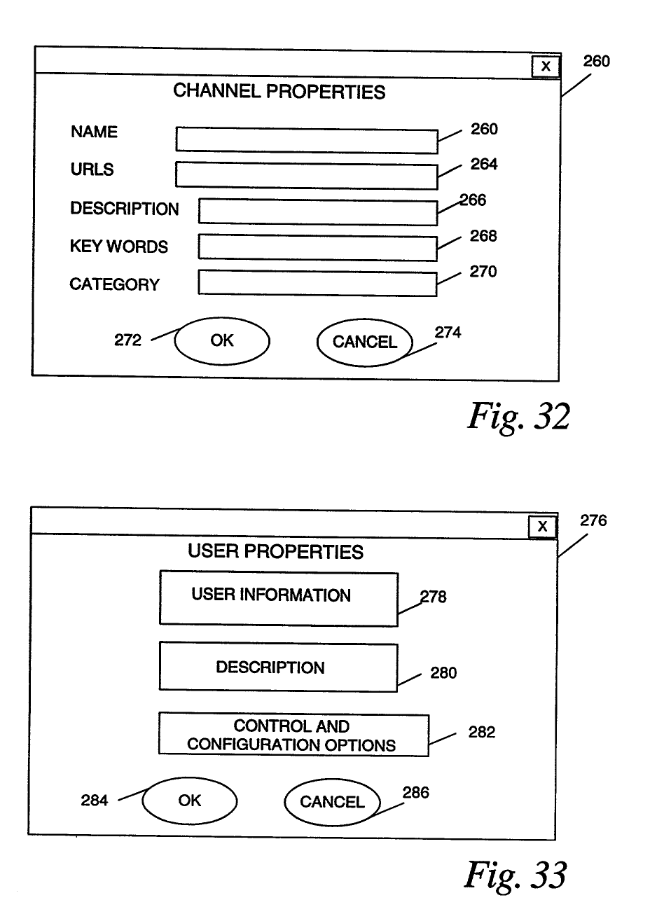

If the user selected properties, the selection navigator displays properties for the selected item (step 236). FIGS. 32-35 provide exemplary screens in order to display and specify, respectively, channel properties, user properties, user group properties, and node properties. These screens can be displayed overlaid on screen 160, for example. Each screen can include sections for a user to enter or specify the particular properties such as using a keyboard or key pad to type in the desired information. Properties can also be entered in other ways.

If the selected item in step 234 is a channel, the selection navigator can display a screen 260 shown in FIG. 32. Channel properties can include a name 262, one or more URLs 264, a description 266, key words 268, and a category 270. The name can include, for example, the word or words displayed to the user in the representation of the structure (for example, see FIGS. 6 and 7). The key words can be used for searching, for example, and the category can be used to organize channels. The one or more URLs associated with the node can be used, for example, to link the channel with local or remote content. Therefore, when a user selects or “clicks on” the channel, the selection navigator can use the URL associated with the channel to retrieve content for it. As an alternative to the use of URLs, any address or other type of link or pointer can be used. The user can select a section 272 to save the entered channel properties or select a section 274 to cancel any new entered information for the channel properties.

If the selected item in step 234 is a user, the selection navigator can display a screen 276 shown in FIG. 33. User properties can include user information 278 such as a name, a description 280, and control and configuration options 282. The control and configuration options can be used to specify how and if this particular user can change or manipulate a node structure. For example, the user can be permitted to add nodes, delete nodes, move nodes, make no changes to nodes, or execute other options. A user categorized as an administrator, for example, can specify such options for users within the system server. Each user can alternatively specify the options for nodes in the user's node structure. Therefore, each user can control how the users and user groups having access to that user's node structure can interact with it. The user can select a section 284 to save the entered user properties or select a section 286 to cancel any new entered information for the user properties.

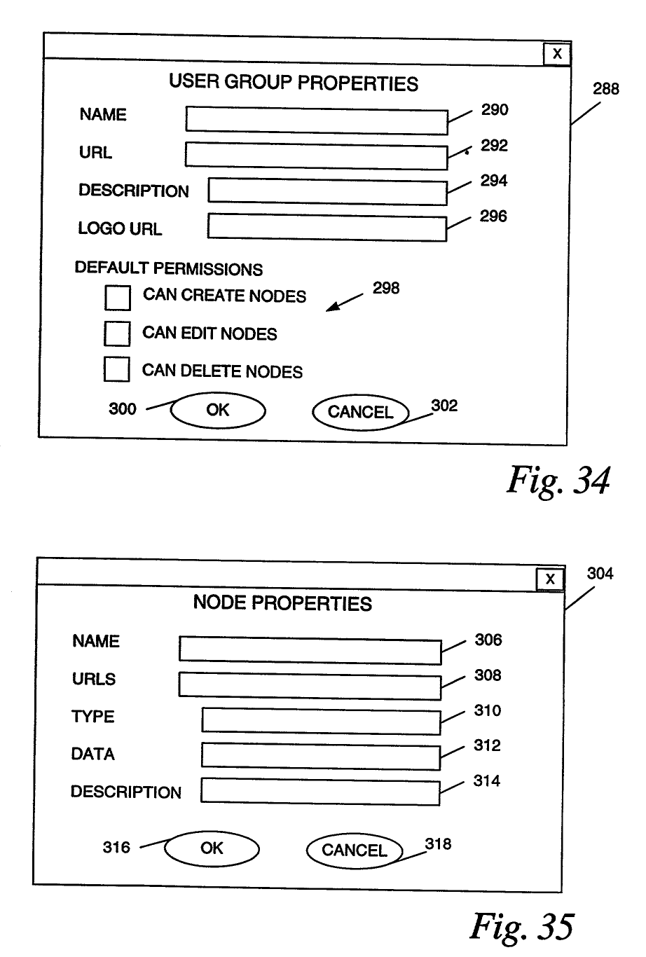

If the selected item in step 234 is a user group, the selection navigator can display a screen 288 as shown in FIG. 34. User group properties can include a name 290, a URL 292, a description 294, a logo URL 296, and default permissions 298. The logo URL can include, for example, a name to be displayed for the group in the representation of the node structure. The URL can be used to link local or remote content with the user group. The permissions relate to how the specified user group can modify nodes, if at all. For example, as shown in section 298, user groups can be permitted to create nodes, edit nodes, delete nodes, or perform any combination of those options. The default settings for permissions 298 can include any particular settings, and a user such as an administrator can optionally change the permissions for each particular user in the user group. The selection navigator can thus access these permissions to determine if and how particular users can modify nodes. The user can select a section 300 to save the entered user group properties or select a section 302 to cancel any new entered information for the user group properties.

If the selected item in step 234 is a node or master node, the selection navigator can display a screen 304 as shown in FIG. 35. Node properties can include a name 306, a URL 308, a type 310, data 312, and a description 314. The URL can be used to link local or remote content with the node. The type can be used to organize the nodes by specifying various types for nodes. The data can include a search query to obtain sub-nodes for a query node, as explained above. The user can select a section 316 to save the entered node properties or select a section 318 to cancel any new entered information for the node properties. Master nodes can have the same types of properties as nodes and thus, in this example, use the same screen 304 to specify and receive their properties.

For any of the properties described above, the screens and information to be entered or specified, as shown, are provided as exemplary properties for the items. Implementations of a selection navigator can include different properties. Also, each of the properties screens can optionally include a history option for selection by a user to view the history for the corresponding item, and the history can include saved information specifying creation and modifications to the item. The information specifying the properties for items in the user's node structure is preferably downloaded with it in step 224.

Referring back method 220, the selection navigator receives information for the properties for the selected item, possibly including permissions (step 238). The information for the properties can be entered via, for example, one of the screens shown in FIGS. 32-35 depending upon the item selected. The selection navigator uses the entered information to update the properties for the item in the local cache (step 240).

The selection navigator also detects whether the user selects a custom node option (step 242). The selection navigator can possibly display default custom nodes in the representation of the node structure for selection by the user, or allow the user to select custom nodes in other ways such as through a menu. If the user selects a custom node, the selection navigator determines if the user selects a default custom node or wants to design a custom node (step 253). The available default custom nodes can be specified, for example, in a pull-down menu accessed from the toolbar or through node properties. Default custom nodes refers to those custom nodes preconfigured. Certain types of custom nodes can be preconfigured with particular fields and an arrangement of them for various common types of applications of nodes, for example, making it even easier for a user to customize a node structure.

If the user selected a default custom node, the selection navigator receives a selection of a particular custom node among the available default custom nodes (step 254). The selection navigator displays the properties section for the selected custom node (step 255), and the configuration of that properties section will depend upon the custom node selected. A user can then enter data or information into the properties section. The selection navigator receives the information for the properties, possibly including permissions (step 256), and it updates the node structure in the local cache to include the selected custom node and entered properties for it (step 257). The properties for a custom node can include a query used to obtain and expand sub-nodes for the custom node, as explained above.

If the user had not selected a default custom node (step 253), the selection navigator can permit the user to configure a custom node. The selection navigator receives information for the custom node properties including fields and descriptors (step 244).

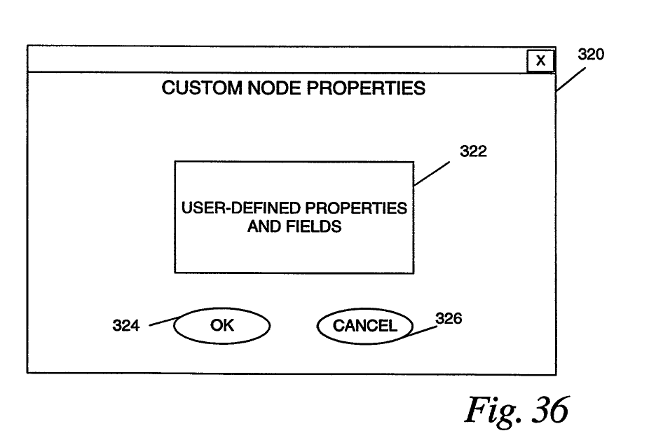

FIG. 36 is an example of a screen 320 for specifying custom node properties. Screen 320 includes a section 322 for the user to specify particular fields and descriptions. Section 322 can be implemented in any number of ways for allowing a user to specify fields and descriptions; for example, it can include sections for a user to specify a number of fields and then a descriptor for each field. The user can select a section 324 to save the entered custom node properties or select a section 326 to cancel any new entered information for the custom node properties. Custom nodes thus allow users to tailor individual nodes within their node structures based upon their own particular requirements or desires.

Referring back to method 220, upon the user selecting section 324 in screen 320, the selection navigator generates the specified custom node (step 246). In particular, it generates meta data, in this exemplary implementation, for the custom nodes using the properties entered by the user, and it saves the custom node in the local cache storing the node structure. The user can then drag and drop copies of the custom node to other locations in the node structure using the steps 228, 230, and 232 described above for updating the node structure.

If the user remains on-line (step 248), the selection navigator continues to monitor the user's interaction for dynamically updating the node structure. The methods above for inserting items, updating properties, and generating custom nodes, can be executed in any order as the user remains on-line and interacts with the displayed node structure and associated content.

If the user logs off such as via closing the browser (step 248), the selection navigator transmits the updated node structure and properties from the local cache to the system server (step 250). It can transmit the information to the server over network 59 such as the Internet, and the information can be formatted or packaged in any way suitable for network transmission. The system server can then save the changes to the user's node structure and propagate the changes to master nodes and master structures to other node structures in which they are located (step 252). Since the system server preferably saves or has access to the various node structures for all users, the system server can make the changes for user groups, or other items, linked to master nodes.

The following provides examples for use of master nodes and custom nodes to illustrate an implementation. A user can specify a master node, for example, in order to publish a newsletter to user groups. The user moves, such as via dragging and dropping, copies of the master node into the subscribed user groups as illustrated in FIG. 29. The user can also specify a particular master structure for the master node; for example, the master node can have sub-nodes for each issue of the newsletter. In the properties for the master node, the user can specify a URL identifying a location of the stored newsletter, as illustrated in field 308 of the node properties in FIG. 35. If the user has a new newsletter to publish, the user need only change the URL in the master node to “point to” the stored location of the new newsletter, and that new URL is propagated through to the copies of the master nodes. Therefore, the user is not required to copy the newsletter into each individual user group.

As an example of use of custom nodes, a user can specify a custom node for generation of music or other audio information. In this exemplary custom node, the user can specify fields and properties relating to sounds. Each custom node can be linked with audio content, such as an audio file identified by a URL in the properties for each custom node. The user can drag and drop content into the custom nodes and combine them in various ways to make music or other audio information from the combinations of sounds.

These two examples for master nodes and custom nodes are provided for illustrative purposes only, and many other applications and implementations are possible.

While the present invention has been described in connection with an exemplary embodiment, it will be understood that many modifications will be readily apparent to those skilled in the art, and this application is intended to cover any adaptations or variations thereof. For example, different navigator processing, labels for the database schema and routines, and network addresses, may be used without departing from the scope of the invention. This invention should be limited only by the claims and equivalents thereof.

1. A method for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the method comprising:
displaying a representation of the structure;
receiving a selection of a node during a user session;
receiving an identification of a location to insert the node within the hierarchical structure during the user session;
temporarily inserting the node within the hierarchical structure during the user session; and
establishing the node as part of the hierarchical structure for retrieval and use during a subsequent user session.

2. The method of claim 1 wherein the inserting step includes locally caching an identification of the node and the location.

3. The method of claim 1 wherein the inserting step includes initially assigning a random number to the node.

4. The method of claim 1 wherein the establishing step includes assigning a key to the node, wherein the key is selected based upon the location.

5. The method of claim 4 wherein the assigning step includes assigning a plurality of identifiers to the node.

6. The method of claim 5 wherein the assigning step includes assigning an identifier to the node providing an address path of the node within the hierarchical structure.

7. The method of claim 1 wherein the establishing step includes transmitting an identification of the node and the hierarchical structure to a remote server.

8. The method of claim 1 wherein the receiving the identification of the location step includes tracking a cursor position to detect placement of the node within the displayed representation.

9. The method of claim 8 wherein the tracking step includes detecting a user dragging and dropping the node within the displaying representation using a cursor-control device.

10. The method of claim 1, further including modifying the displayed representation to indicate the node inserted into the hierarchical structure.

11. The method of claim 1 wherein the displaying step includes displaying icons having connections, the icons representing the channel node, the sub-nodes, and the node, and the connections representing the hierarchical relationships between the channel node, the sub-nodes, and the node.

12. A method for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the method comprising:
displaying a representation of the structure, including displaying at least one master node;
receiving a selection of the master node during a user session;
receiving an identification of a location to insert the master node within the hierarchical structure during the user session;
inserting a representation of the master node in the identified location of the hierarchical structure;
receiving changes to the master node; and
automatically propagating the changes to the inserted master nodes in the hierarchical structure.

13. The method of claim 12, further including:
displaying at least a master structure for the master node, the master structure specifying a node structure associated with each inserted master node in the hierarchical structure;
receiving structural changes to master node; and
automatically propagating the structural changes to the inserted master nodes in the hierarchical structure.

14. The method of claim 12 wherein the receiving changes step includes receiving at least one of the following associated with the master node: content; a link to content; and a network address.

15. The method of claim 12, further including associating each master node with a particular user group.

16. The method of claim 12, further including specifying properties for each master node.

17. The method of claim 16 wherein the receiving changes step includes receiving information for the properties.

18. The method of claim 16 wherein the specifying properties step includes specifying permissions associated with users having access to the master node, the permissions specifying changes the users can make to the master node.

19. The method of claim 18 wherein the specifying permissions step includes specifying default permissions.

20. A method for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the method comprising:
displaying a representation of the structure;
receiving a selection of a node during a user session;
receiving user-specified properties for the node;
classifying the node as a custom node controlled by the user-specified properties;
receiving an identification of a location to insert the custom node within the hierarchical structure during the user session; and
inserting a representation of the custom node in the identified location of the hierarchical structure.

21. The method of claim 20 wherein the classifying step includes specifying data for the custom node based upon the user-specified properties.

22. The method of claim 20 wherein the receiving the selection step includes receiving selection of a particular one of a plurality of preconfigured custom nodes.

23. The method of claim 20, further including receiving identification of user-specified fields for the custom node.

24. The method of claim 20 wherein the receiving the properties step includes receiving a query used to retrieve sub-nodes for the custom node.

25. The method of claim 24 wherein the receiving the properties step includes receiving as the query an identification of a location and a term for use in performing a search of the term at the location to obtain sub-nodes for the custom node.

26. An apparatus for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the apparatus comprising:
a display module for displaying a representation of the structure;
a selection module for receiving a selection of a node during a user session;
a receive module for receiving an identification of a location to insert the node within the hierarchical structure during the user session;
an insert module for temporarily inserting the node within the hierarchical structure during the user session; and
a module for establishing the node as part of the hierarchical structure for retrieval and use during a subsequent user session.

27. The apparatus of claim 26 wherein the insert module includes a module for locally caching an identification of the node and the location.

28. The apparatus of claim 26 wherein the insert module includes a module for initially assigning a random number to the node.

29. The apparatus of claim 26 wherein the module for establishing includes an assign module for assigning a key to the node, wherein the key is selected based upon the location.

30. The apparatus of claim 29 wherein the assign module includes a module for assigning a plurality of identifiers to the node.

31. The apparatus of claim 30 wherein the assign module includes a module for assigning an identifier to the node providing an address path of the node within the hierarchical structure.

32. The apparatus of claim 26 wherein the module for establishing includes a module for transmitting an identification of the node and the hierarchical structure to a remote server.

33. The apparatus of claim 26 wherein the receive module includes a module for tracking a cursor position to detect placement of the node within the displayed representation.

34. The apparatus of claim 33 wherein the tracking module includes a module for detecting a user dragging and dropping the node within the displaying representation using a cursor-control device.

35. The apparatus of claim 26, further including a module for modifying the displayed representation to indicate the node inserted into the hierarchical structure.

36. The apparatus of claim 26 wherein the display module includes a module for displaying icons having connections, the icons representing the channel node, the sub-nodes, and the node, and the connections representing the hierarchical relationships between the channel node, the sub-nodes, and the node.

37. An apparatus for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the apparatus comprising:
a display module for displaying a representation of the structure, including displaying at least one master node;
a selection module for receiving a selection of the master node during a user session;
a receive module for receiving an identification of a location to insert the master node within the hierarchical structure during the user session;
an insert module for inserting a representation of the master node in the identified location of the hierarchical structure;
a module for receiving changes to the master node; and
a module for automatically propagating the changes to the inserted master nodes in the hierarchical structure.

38. The apparatus of claim 37, further including:
a module for displaying at least a master structure for the master node, the master structure specifying a node structure associated with each inserted master node in the hierarchical structure;
a module for receiving structural changes to master node; and
a module for automatically propagating the structural changes to the inserted master nodes in the hierarchical structure.

39. The apparatus of claim 37 wherein the module for receiving changes includes a module for receiving at least one of the following associated with the master node: content; a link to content; and a network address.

40. The apparatus of claim 37, further including a module for associating each master node with a particular user group.

41. The apparatus of claim 37, further including a module for specifying properties for each master node.

42. The apparatus of claim 41 wherein the module for receiving changes includes a module for receiving information for the properties.

43. The apparatus of claim 41 wherein the module for specifying properties includes a module for specifying permissions associated with users having access to the master node, the permissions specifying changes the users can make to the master node.

44. The apparatus of claim 43 wherein the module for specifying permissions includes a module for specifying default permissions.

45. An apparatus for modifying an hierarchical structure for electronically organizing content in a channel communicating over a network with content sites, the structure specifying a channel node having a network address and hierarchically arranged sub-nodes each selectively having a pointer to particular content and links specifying the hierarchy, the apparatus comprising:
a display module for displaying a representation of the structure;
a selection module for receiving a selection of a node during a user session;
a receive module for receiving user-specified properties for the node;
a classify module for classifying the node as a custom node controlled by the user-specified properties;
a module for receiving an identification of a location to insert the custom node within the hierarchical structure during the user session; and
an insert module for inserting a representation of the custom node in the identified location of the hierarchical structure.

46. The apparatus of claim 45 wherein the classify module includes a module for specifying data for the custom node based upon the user-specified properties.

47. The apparatus of claim 45 wherein the selection module includes a module for receiving selection of a particular one of a plurality of preconfigured custom nodes.

48. The apparatus of claim 45, further including a module for receiving identification of user-specified fields for the custom node.

49. The apparatus of claim 45 wherein the receive module includes a module for receiving a query used to retrieve sub-nodes for the custom node.

50. The apparatus of claim 49 wherein the receive module includes a module for receiving as the query an identification of a location and a term for use in performing a search of the term at the location to obtain sub-nodes for the custom node.

51. A structure for electronically organizing content in a channel communicating over a network with content sites, comprising:
a master node having a network address and having properties specifying a location of content associated with the master node;
a master structure specifying a structure of sub-nodes for the master node;
copies of the master node associated with user groups; and
links between the master node and the copies of the master node, wherein the links are used to propagate the properties and the master structure to the copies of the master node.

52. A structure for electronically organizing content in a channel communicating over a network with content sites, comprising:
a custom node having a network address, wherein the custom node has user-specified properties;
sub-nodes each selectively having a pointer to particular content;
links between the custom node and the sub-nodes;
pages associated with the sub-nodes; and
links between the pages and the sub-nodes.

53. The structure of claim 52 wherein the custom node has user-specified fields.

54. The structure of claim 52 wherein the custom node has a query used to retrieve sub-nodes for the custom node.

55. The structure of claim 54 wherein the query specifies an identification of a location and a term for use in performing a search of the term at the location to obtain sub-nodes for the custom node.
